(19) United States
(12) Patent Application Publication
(10) Pub. No.: US 2026/0185573 A1
(43) Pub. Date: Jul. 2, 2026

(54) SYSTEMS AND METHODS FOR BEDDING DISC BRAKES OF CYCLES

(71) Applicant: SINTER LJUBLJANA D.O.O., 1000 Ljubljana (SI)

(72) Inventors: Edvard CIBULA, Starse (SI); Sven CURILA, Ljubljana (SI); Bruce FINA, Saratoga Springs, NY (US)

(73) Assignee: SINTER LJUBLJANA D.O.O., 1000 Ljubljana (SI)

(21) Appl. No.: 19/542,909

(22) Filed: Feb. 18, 2026

Related U.S. Application Data
(63) Continuation-in-part of application No. PCT/EP2024/088273, filed on Dec. 20, 2024.

(51) Int. Cl. F16D 65/00; B60T 17/22; B62J 50/00; F16D 66/00

(52) U.S. Cl. CPC F16D 65/0037; B60T 17/221; B62J 50/00; F16D 66/00; F16D 2066/001

(57) ABSTRACT

Cycle disc brake bedding-in systems and methods. The systems comprise a base defining an opening, a roller assembly within the opening, an electric motor configured to rotate the roller assembly, at least one user interface comprising a display portion and an input interface portion that inputs operational parameters, and at least one controller. The at least one controller monitors real-time operational statuses of the system, and controls the electric motor and the at least one user interface, based on input operational parameters and the real-time operational statuses, to perform a bedding-in method of a disc brake of a wheel of a cycle. The process comprises cycles of braking and subsequent cooling operations while the wheel is rotated via the roller assembly and the real-time operational statuses are indicated by the display portion to instruct the user to operate the disc brake in accordance with the braking and cooling operations.

### CROSS-REFERENCE TO RELATED APPLICATION

This application is a U.S. bypass continuation-in-part application of PCT International Application No. PCT/EP 2024/088273 filed on Dec. 20, 2024, entitled A Device And A Method For Bedding-In Disc Brakes For Bicycles, which is hereby incorporated herein by reference in its entirety.

### FIELD OF THE DISCLOSURE

This invention relates generally to systems, devices and methods for bedding disc brakes of cycles (e.g., bicycles), and more particularly related to cycle disc brake bedding-in systems, devices and methods that produce enhanced brake pad material transfer layers on brake rotors/discs that.

### BACKGROUND

Bicycles, tricycles and the like (hereinafter cycles) often include a braking mechanism that slows the rotation of at least one respective wheel. One type of cycle braking mechanism is a disc brake system. Many modern and/or high-quality user-powered cycles and externally powered cycles (such as electronic bicycles or “e-bikes”) utilize disc brake systems given their superior braking capabilities as compared to other brake designs.

As shown in FIGS. 1-2, a disc brake system 10 of a cycle typically uses a caliper 12 mounted adjacent to a respective wheel 14. A brake disc 16 (referred to as a brake rotor, or simply a rotor) is affixed to the wheel 14 such that the rotor 16 and the wheel 14 are rotationally locked together (and rotate together about a common axis of rotation 18). The rotor 16 and the caliper 12 are configured such that the rotor 16 passes through an opening in the caliper 12 as it rotates about the axis of rotation 18.

The caliper 12 typically includes pairs of pistons 20 (e.g., two or four pistons) positioned on opposing sides of the rotor 16 (and the opening) within chambers that are sealed 22. For example, 2-piston calipers 12 are becoming common for road and cross-county cycles, and 4-piston calipers 12 are often used mountain bikes and cycles designed or used for aggressive riding. More pistons generally produce more braking power. However, single piston disc brake systems also exist.

Brake pads 28 are positioned in front of each piston 20 between the rotor 16 and the pistons 20, as shown in FIG. 1. Cycle/bike brake pads 28 are consumable friction components that press against the rotor 16, as explained below, and come in various materials (resin, metallic, semi-metallic) suited for different riding conditions, offering choices in durability, performance, and noise. Cycle/bike brake pads 28 typically consist of a friction material bonded to a metal or ceramic backing plate, and wear out and need replacement over time as the friction material slowly wears down. Different cycle/bike brake pads 28 comprising differing physical configurations and/or compositions offer different advantages and disadvantages (e.g., wet-weather performance, lifespan, braking response, noise levels, affected by high/low temperatures, etc.). For example, organic disc brake pads (generally made up of Kevlar, rubber and silica, bound together with resin), sintered or metallic disc brake pads (generally made up of a mixture of metallic particles pressed together) and semi-metallic pads (generally made up of an organic compound with incorporated metal particles) are common cycle/bike brake pad configurations/types.

As shown in FIGS. 1 and 2 respectively, hydraulic and hybrid hydraulic-mechanical caliper designs are operated by high-pressure hydraulic fluid 26, such as but not limited to an oil, that is present within the chambers of the caliper 12 behind the pistons 20. The hydraulic fluid 26 is pressurized by a brake handle/lever or other mechanism 30, which is often located on a handle or handlebar of the cycle. A hybrid hydraulic-mechanical caliper design includes a lever arm 32 at the caliper 12 that is operated by the brake handle/mechanism 30 that pressurizes the hydraulic fluid 26 in the caliper 12 as shown in FIG. 2, while in a hydraulic caliper design the hydraulic fluid 26 extends to the brake handle/mechanism 30 and is directly pressurized by the brake handle/mechanism 30. In mechanical caliper designs (not shown), the caliper is devoid of hydraulic fluid, and instead operates the piston(s) by a mechanical means (typically via a lever arm).

Generally, cycle/bike disc brake systems (of all types) are operated by user activation of the brake handle/mechanism 30, which causes one or more pistons 20 of the caliper 12 to force the brake bads 22 against the sides of the rotor 16 to produce a braking power/force that slows the rotation of the respective wheel. It is noted that brake handle/mechanisms 30 are typically configured for manual operation, but non-manual (e.g., electronic) caliper activation mechanisms also exist. As shown in FIGS. 1 and 2, in hydraulic and hybrid hydraulic-mechanical designs, when the hydraulic fluid 26 is pressurized via activation of a brake handle/mechanism 30, the pressurized fluid 26 forces the piston(s) 20 toward the rotor 16, which in turn forces the brake pads 22 against the sides of the rotor 16 to produce the braking power/force. In mechanical caliper designs, activation of the brake handle/mechanism mechanically forces the piston(s) toward the rotor, which in turn forces the brake pads against the sides of the rotor to produce the braking power/force.

The brake pads 28 of disc brake systems are thereby squeezed or compressed against the sides of the brake rotor 16 during a braking operation to slow the rotation of the rotor 16 and, in turn, slow the rotation of the wheel 14 to thereby slow (and ultimately stop, if desired) translation of the cycle. It is noted that disc brake systems with only one piston, only one of the brake pads 22 is translated via a piston 20 against the side of the rotor 16, which in turn deflects the rotor 16 into a piston-less brake pad 22 positioned on the opposing side of the rotor 16, to effectuate braking.

As shown in FIGS. 1 and 2, hydraulic and hybrid hydraulic-mechanical caliper designs are differentiated by how the caliper 12 is activated/operated. As shown in FIG. 1, in a hydraulic caliper design, the disc brake system 10 includes a tube or hose 24 extending between the caliper 12 and the brake handle/mechanism 30 which houses the hydraulic fluid 26. The hydraulic fluid 26 thereby extends from the brake handle/mechanism 30 to the caliper 12, and the brake handle/mechanism 30 pressurizes the hydraulic fluid 26. As shown in FIG. 2, in a hybrid hydraulic-mechanical caliper design, the tube 24 extending between the caliper 12 and the brake handle/mechanism 30 houses a cable 27 as opposed to hydraulic fluid. The cable 27 extends from the brake handle/mechanism 30 to the lever arm 32 of the caliper 12, and the brake handle/mechanism pulls and/or pushes the cable 27 through the tube 24 to operate the lever arm 32 (and thereby operated the caliper 12 itself). It is noted that mechanical caliper designs are operated by a cable substantially similarly to that of hybrid hydraulic-mechanical caliper designs.

There are two basic types of friction mechanisms that occur between the brake pads and the rotor in many cycle disc brake systems which together produce the total braking power/force: abrasive friction and adherent (or adhesive) friction. Abrasive friction occurs as the brake pads physically grind against the rotor, a process similar to using sandpaper, to convert kinetic energy (motion) into heat. Abrasive friction thereby involves the continuous wearing away of the material of both the brake pads and rotor which dissipates the kinetic energy of the rotor. Adherent friction involves the transfer of a very thin layer of pad material from the brake pads onto the rotor, and then the creation/formation, and subsequent breaking, of chemical bonds between the brake pad and the layer of transferred pad material on the surfaces of rotor. The brake pads thereby adhere to these transferred cohesive friction layers on the rotor, rather than grinding the rotor. The making and breaking, and re-making and re-braking, of the molecular bonds between the transferred/formed cohesive friction layers on the rotor and the pad brake pads is analogous to two pieces of tape being repeatedly adhered together on their sticky-sides and pulled apart. Braking force is generated in adherent friction by the making and breaking (and repeating the making-and-breaking cycle) of these molecular bonds, which converts the kinetic energy of the rotor to heat efficiently. Adherent friction often occurs with ceramic and non-asbestos organic (NAO) brake pads, and/or with brake pads that include metal lubricant materials (e.g., metal sulfides), for example.

Adherent friction of disc braking system of cycles thus requires a very thin layer of break pad material transferred or imprinted onto the surfaces of the rotor. The initial application or formation of this transfer layer of pad material deposited onto the rotor surfaces is a process called “bedding-in” or “burnishing” of the disc brakes/rotors. While the pad material transfer layer is reformed or reburnished on the rotor during use to some degree, the configuration of the initial transfer layer is crucial for brake pad performance as it controls the friction coefficient, wear and other tribological properties of the disc brake system for at least an extended period of time (and potential for the life of the brake pads). If the initial transfer layer is not formed correctly or ideally, the performance of the brake pad/disc brake system (e.g., coefficient of friction) is decreased initially and over an extended period of time. A bedding-in process should thus be performed upon an initial installation of a disc brake system, each time replacement pads, rotors and/or calipers are installed, and after cleaning and/or maintenance of a disc brake system.

Typical disc brake systems on cycles are not bedded in by cycle or brake manufacturers. For example, many disc brake systems and/or components thereof (e.g., pads) are after-market components that are added to a cycle. In fact, many times a disc brake system are never subjected to a particular bedding-in process before everyday use. Often, a disc brake system is installed, and the cycle is immediately released to the user for use. A bedded-in a disc brake system provides greater initial performance and consistent long-term benefits through multiple brake cycles because of the formation of the initial transfer layer.

Those that do take the extra step in bedding-in their cycle disc brakes do so via an inexact manual process of performing several braking cycles where a user rides the cycle and performs a series of accelerations and then decelerations via the disc brake system. This manual process, often referred to as “parking lot bedding-in” is time-consuming and inaccurate in that the initial transfer layer is not ideally formed. Typical end users and cycle salespersons/mechanics are unaware of the exact particular transfer layer characteristics or configurations that would result in an optimal or high quality braking performance for each available cycle disc braking system (e.g., pad and/or rotor and/or caliper), no less the particular bedding-in process parameters to achieve such an ideal transfer layer that provides optimal brake performance. Accordingly, disc brake system on cycles are not properly (or ideally) bedded-in, but rather bedded-in utilizing a manual inexact general bedding-in process that produces inferior braking performance (e.g., coefficient of friction) initially and over time as compared to brake systems when optimally bedded-in (e.g., not ideal initial transfer layers).

Accordingly, systems and methods for bedding-in cycle disc brake systems that produce superior initial break pad material transfer layers on rotors that result in high-performance brake performance initially and over time are desirable.

While certain aspects of conventional technologies have been discussed to facilitate disclosure of Applicant's inventions, the Applicant in no way disclaims these technical aspects, and it is contemplated that the inventions may encompass one or more conventional technical aspects.

In this disclosure, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

Shortcomings of the prior art can be overcome and benefits as described later in this disclosure can be achieved through the cycle disc brake bedding-in systems and methods of the current disclosure. For example, the bedding-in systems and methods provide automated bedding-in systems and methods address shortcomings of the traditional manual bedding-in process. Various examples of the cycle disc brake bedding-in systems and methods related thereto, including and excluding the additional examples enumerated below, in any combination (provided these combinations are not inconsistent), overcome these shortcomings.

The presently disclosed cycle disc brake bedding-in systems and methods may address one or more of the problems and deficiencies of current cycle disc brake bedding-in systems and methods. However, it is contemplated that the presently disclosed cycle disc brake bedding-in systems and methods may prove useful in addressing other problems and deficiencies in a number of technical areas. Therefore, the presently disclosed cycle disc brake bedding-in systems and methods should not necessarily be construed as limited to addressing any of the particular problems or deficiencies discussed herein.

The presently-disclosed cycle disc brake bedding-in systems and methods provide a controlled and guided process for bedding-in disc brakes of cycle (e.g., bikes), which produces increased brake pad/brake performance and safety as compared to not bedding-in the brakes and/or bedding-in the brakes via another process (e.g., a typical parking-lot bedding-in process), constant brake feel, instant brake power, and requires only minimal labor. The presently disclosed disc brake bedding-in systems and methods reduce the time and costs of cycle disc brake bedding-in as compared to current cycle disc brake bedding-in processes.

The presently-disclosed disc brake bedding-in systems and methods efficiently (e.g., less than 10 minutes per cycle) and effectively bed-in cycle (e.g., bicycle) disc brakes such that the bedded-in disc brakes produce improved (e.g., by at least about 20%) braking performance (e.g., achieved coefficients of friction) both initially and over time (e.g., over many brake cycles, such as over hundreds of brake cycles) as compared to current bedding-in system/methods. The initial friction benefits of the presently disclosed disc brake bedding-in systems and methods over current bedding-in system/methods may present over the entire lifespan of the disc brakes (e.g., the lifespan of the brake pads thereof).

The presently disclosed disc brake bedding-in systems and methods require less processing/procedure timeframes, and produce a high quality, consistently bedded-in cycle disc brakes. The systems and methods eliminate “hotspots” on the pad surface that are formed with current bedding-in system/methods, leading to quieter braking performance. The systems and methods also provide a more even pad and/or transfer layer on the rotor surface than with current bedding-in system/methods, resulting in improved wear of the brakes.

In some embodiments, the disc brake bedding-in systems and related disc brake bedding-on processes/methods of the present disclosure utilize a base defining an opening, a roller assembly within the opening, an electric motor configured to rotate the roller assembly, at least one user interface comprising a display portion and an input interface portion that inputs operational parameters, and at least one controller. The at least one controller monitors real-time operational statuses of the system, and controls the electric motor and the at least one user interface, based on input operational parameters and the real-time operational statuses, to perform a bedding-in method of a disc brake of a wheel of a cycle (e.g., a bicycle). The process comprises cycles of braking and subsequent cooling operations while the wheel is rotated via the roller assembly and the real-time operational statuses are indicated by the display portion to instruct the user to operate the disc brake in accordance with the braking and cooling operations.

For example, in one aspect, the present disclosure provides a system for bedding-in a disc brake of a wheeled cycle (e.g., a bicycle) that comprises a brake rotor fixed to a wheel of the cycle and a pair of brake pads mounted on a caliper that selectively compress against the brake rotor while the wheel and rotor are rotating during a braking operation of the disc brake. The system comprises a base defining an opening configured to receive the wheel of the wheeled cycle, and a roller assembly comprising a rear roller and a front roller each rotatably coupled with the base and extending across the opening, the rear and front rollers configured to engage the wheel of the cycle. The system further comprises an electric motor mounted to the base and operatively coupled with the roller assembly configured to rotate at least one of the rear and front rollers to rotate the wheel and rotor of the cycle. The system also comprises at least one user interface comprising a display portion and an input interface portion that inputs at least one operational parameter. The system further comprises at least one controller that monitors real-time operational statuses of the system, and controls the electric motor and the at least one user interface, based on the at least one operational parameter input by the input interface portion and the real-time operational statuses, to execute a bedding-in process that beds-in the disc brake of the wheel of the wheeled cycle. The bedding-in process comprises a plurality of cycles of a braking operation and subsequent cooling operation while the wheel is rotated via the roller assembly and at least some of the real-time operational statuses are indicated by the display portion, the braking operations comprising the disc brake being activated by a user within a defined braking level for a braking timeframe, and the cooling operations comprising the disc brake not being activated by the user for a cooling timeframe. The real-time operational statuses that are indicated by the display portion during the bedding-in process instruct the user to operate the disc brake in accordance with the braking and cooling operations, and comprise: an indication to the user to perform a first braking operation; an indication to the user of a real-time brake level compared to the defined braking level during the first braking operation; and an indication to the user to perform a first cooling operation after the first braking operation; an indication to the user to perform a second braking operation after the first cooling operation; an indication to the user of a real-time brake level compared to the defined braking level during the second braking operation; and an indication to the user to perform a second cooling operation after the first braking operation.

In some embodiments of the system, the during the bedding-in process, the at least one controller determines a baseline speed of rotation of the roller assembly with the wheel engaged with the front and rear rollers prior to the braking operations, and the at least one controller compares the real-time speed of rotation of the roller assembly during a braking operation to the baseline speed of rotation to determine the real-time brake level compared to the defined braking level during a braking operation. In some such embodiments of the system, the at least one controller determines the defined braking level as a defined reduction of the baseline speed of rotation.

In some embodiments of the system, the braking timeframe of the braking operations is a fixed timeframe that is set via the at least one operational parameter input by the input interface portion, and the cooling timeframe of the cooling operations is a fixed timeframe that is set via the at least one operational parameter input by the input interface portion.

In some embodiments of the system, the system further comprises a temperature sensor configured to sense the temperature of the rotor and/or a brake pad of the brake pads of the disc brake of the cycle, and the at least one controller determines the braking timeframe of the braking operations and the cooling timeframe of the cooling operations based on the sensed temperatures of the rotor and/or a brake pad during the respective braking and cooling operations. In some such embodiments of the system, the at least one controller determines the braking timeframe of the braking operations and the cooling timeframe of the cooling operations based on the sensed temperatures and a defined total amount of heat or a maximum temperature.

In some embodiments of the system, the at least one user interface comprises a local user interface that is mounted on the base and operatively coupled with the at least one controller via wiring. In some embodiments of the system, the at least one user interface comprises a remote user interface that is physically separated from the base and communicates wirelessly with the at least one controller.

In some embodiments of the system, the at least one controller comprises a processor and memory, a plurality of differing bedding-in processes are stored within the memory of the at least one controller, the plurality of differing bedding-in processes comprising at least one of differing numbers of cycles of the braking and cooling operations and differing braking timeframes, and the at least one operational parameter input by the input interface portion of the at least one user interface comprises a user selection of one of the plurality of differing bedding-in processes such that the at least one controller executes the selected one of the plurality of differing bedding-in processes.

In some embodiments of the system, the input interface of the at least one user interface is configured obtain at least one disc brake parameter of the disc brake of the cycle from the user, at least one of the at least one user interface and the at least one controller is configured to determine or select a corresponding bedding-in process with particular braking and cooling operations suited for the disc brake of the cycle based on the obtained at least one disc brake parameter, and the at least one controller is configured to execute the determined or selected corresponding bedding-in process. In some such embodiments of the system, the at least one disc brake parameter of the disc brake of the cycle comprises at least one of a number of pistons of the caliper of the disc brake, a size of the rotor of the disc brake, and an identification of the brake pads of the disc brake. In some other such embodiments of the system, the at least one user interface comprises a processor and memory, and is configured to determine or select the corresponding bedding-in process based on the input at least one disc brake parameter, and the input at least one operational parameter comprises an indication of the corresponding bedding-in process.

In some embodiments of the system, the real-time operational statuses that are indicated by the display portion during the bedding-in process further comprise: during a cooling operation, an indication to the user of a real-time status of an amount of time remaining in the cooling timeframe of the cooling operation; and during a braking operation, an indication to the user of a real-time status of an amount of time remaining in the braking timeframe of the braking operation.

In some embodiments of the system, the system further comprises a rotation mode switch or sensor operatively coupled with the at least one controller, the rotation mode switch sets the direction of rotation of the electric motor, and thereby the direction of rotation of at least one of the rear and front rollers via the motor, based on the state of the rotation mode switch. In some such embodiments of the system, the real-time operational statuses that are indicated by the display portion during the bedding-in process further comprise an indication that the direction of rotation of the electric motor is set for a front wheel or a rear wheel of the cycle.

In some embodiments of the system, the system further comprises a wheel insertion sensor configured to detect the presence of the wheel within the opening engaged with the rear and front rollers, and the at least one controller is configured to execute the bedding-in process only when the presence of the wheel is detected by the wheel insertion sensor.

In some embodiments of the system, the real-time operational statuses that are indicated by the display portion are at least one of visually indicated, audibly indicated and tactically indicated to the user.

In some embodiments of the system, the front roller and the rear roller each comprise an area of reduced diameter configured to engage and retain the wheel of the cycle thereon during the bedding-in process.

In some embodiments of the system, the system further comprises an exhaust system configured to remove fumes and airborne particles that are generated during the bedding-in process from an area extending about the system and wheel.

In another example, the present disclosure provides a method of bedding-in a disc brake of a wheeled cycle (e.g., a bicycle) is provided. The disc brake of a wheeled cycle comprises a brake rotor fixed to a wheel of the cycle and a pair of brake pads mounted on a caliper that selectively compress against the brake rotor while the wheel and rotor are rotating during a braking operation of the disc brake. The method comprises providing or obtaining a cycle disc brake bedding-in system, comprising: a base; a roller assembly rotatably coupled with the base; an electric motor mounted operatively coupled with the roller assembly configured to rotate at least one of the rear and front rollers; at least one user interface comprising a display portion and an input interface portion configured to input at least one operational parameter; and at least one controller that monitors real-time operational statuses of the system, and controls the electric motor and the at least one user interface, based on the at least one operational parameter input by the input interface portion and the real-time operational statuses, to execute a bedding-in process that beds-in the disc brake of the wheel of the wheeled cycle while at least some of the real-time operational statuses are indicated by the display portion. The method further comprises utilizing the input interface portion of the at least one user interface to input at least one operational parameter to the system. The method also comprises utilizing the system to bed-in the disc brake of the wheel of the wheeled cycle via the bedding-in process, comprising: initiating a bedding-in process of the system such that the wheel of the wheeled cycle is rotated by the roller assembly; and performing a plurality of cycles of a braking operation followed by a cooling operation while the wheel of the wheeled cycle is rotated by the roller assembly. Each braking operation comprises activating the disc brake for a braking timeframe at a braking level based on the display portion providing an indication to perform the braking operation and providing an indication of a real-time brake level compared to a defined braking level. Each cooling operation comprises deactivating the disc brake for a cooling timeframe based on the display portion providing an indication to perform a cooling operation.

In some embodiments of the method, during each braking operation, the real-time operational statuses that are indicated by the display portion comprise the indication to perform the braking operation, the indication of the real-time brake level compared to the defined braking level, and an indication of a real-time status of an amount of time remaining in the braking timeframe. In some embodiments of the method, during each cooling operation, the real-time operational statuses that are indicated by the display portion comprise the indication to perform the cooling operation, and an indication of a real-time status of an amount of time remaining in the cooling timeframe.

As yet another example, the present disclosure provides for a device or system used in cycle (e.g., bicycle) preparation, maintenance and repair in the field of bedding-in disc brakes thereof. The device/system comprises a roller assembly arranged to receive cycle (e.g., bicycle) wheels ranging from about 20 inches to about 32 inches in diameter while maintaining stable wheel/tire engagement and efficient operation, wherein said roller assembly comprising two rollers, a belt drive, a belt tensioner and a driving pulley. The two rollers include an upper roller installed proximate to the rear/back of an opening in the device and a front roller installed proximate to a front part of the opening. The belt drive operatively connects the two rollers, and synchronizes rotation of the rollers, ensuring smooth operation and constant contact with the cycle wheel/tire. The belt tensioner is operatively coupled with the belt drive and maintains appropriate tension in the belt drive, compensating for variations in component positions due to different wheel sizes. The driving pulley is operatively coupled with the belt drive and transmits power to the roller assembly from a motor (e.g., an electric motor) enabling rotation of the two rollers.

For example, the present disclosure provides for a device or system for bedding-in disc brakes for cycles (e.g., bicycles) that comprises: a housing or base comprising a plurality of panels and/or frame that forms an opening or partly open space arranged to receive a wheel of a cycle (e.g., a bicycle); a controller for performing a method of bedding-in a disc brake of a wheel of a cycle (e.g., bicycle); a roller assembly arranged to receive the wheel of the cycle (e.g., a cycle wheel, such as a bicycle wheel, ranging from about 20 inches to about 32 inches in diameter for example) while maintaining stable tire engagement and efficient operation of the device and the disc brake; and a power source or a plug for connecting an electrical power source to the device to power the device.

In some embodiments of the device/system, the plurality of panels may comprise: a base panel and two side panels defining an opening or partly open space arranged to receive a wheel of a cycle (e.g., bicycle); a front panel covering a part of the base panel next to the opening (the front panel being horizontal to the base panel in some embodiments); a middle panel separating the opening from a space enclosed under the front panel; and a back panel (being parallel to the middle panel in some embodiments) that forms the back of the device.

In some embodiments of the device/system, the roller assembly may comprise an upper or rear roller installed towards the back of the opening, a front roller installed in the front of the opening, and a belt drive operatively connecting the upper or rear roller and the rear roller. The belt drive may be configured to synchronously rotate the upper or rear roller and the rear roller, which may ensure smooth operation and constant contact of the rollers with the wheel/tire. In some such embodiments, the roller assembly may further comprise a belt tensioner, operatively coupled with the belt drive, which maintains appropriate tension in the belt drive to compensate for variations in component positions (e.g., roller positions) due to different wheel sizes. In some such embodiments, the roller assembly may also comprise a driving pulley, operatively coupled with the belt drive, which transmits power to the belt drive from the motor.

In some such embodiments of the device/system, the upper roller, the front roller, the belt drive, the drive tensioner and the driving pulley are spatially arranged by distances A, B, C, D, and E between axis of rotations (or axels) thereof. In some embodiments, distance A is a horizontal spacing between the upper roller and the driving pulley. Distance A is configured/dimensioned to ensure the upper and front rollers can effectively engage cycle wheels/tires of relatively large diameters, such as diameters up to about 36 inches or 32 inches, by positioning the roller assembly high enough with the opening for wheel-base clearance. In some embodiments, distance A is within the range from about 10 to about 150 mm. In some embodiments, distance B is a horizontal spacing between the front roller and the belt tensioner. Distance B is configured/dimensioned to ensure the tensioner effectively maintains belt tension while accommodating smaller wheel sizes, such as wheel as small as about 20 inches. In some embodiments, distance B is within the range from about 250 to about 550 mm. In some embodiments, distance C is a vertical spacing between the upper roller and the driving pulley. Distance C is configured/dimensioned to accommodate varying wheel/tire radii/diameters/sizes from smaller wheels to larger wheels without compromising the belt's alignment. In some embodiments, distance C is within the range from about 80 to about 150 mm. In some embodiments, distance D is a vertical distance between the front roller and the driving pulley. Distance C is configured/dimensioned to ensure that the wheel/tire of the cycle rests in contact with both rollers irrespective of its size. In some embodiments, distance D is within the range from about 20 to about 80 mm. In some embodiments, distance E is a horizontal distance between the driving pulley and the belt tensioner. Distance E is configured/dimensioned to allow the belt tensioner to function effectively across the entire range of wheel sizes by maintaining a consistent belt path. In some embodiments, distance E is within the range from about 10 to about 180 mm.

In some embodiments of the device/system, each of the two rollers has a reduced diameter portion (relative to side or outer portions) and/or flanged or angled sides portions or edges. For example, in some such embodiments, each of the two rollers has a concave profile along its outer circumferential surface that includes angled flanged side portions (e.g., conical surface portions) that form an angle therebetween within the range of about 100 degrees and about 160 degrees (e.g., about 140 degrees). In some embodiments of the device/system, the device/system includes roller protectors that extend below/underneath the rollers.

In some embodiments of the device/system, the device/system comprises at least one controller, such as at least one high-level controller, that controls at least one user interface and/or the roller assembly via at least one motor based on inputs and/or operational parameters. The at least one controller may comprise a processor and memory, such as comprising a microprocessor. For example, the device/system may comprise at least one controller that controls at least one display portion or device of an interface of the device/system such that the interface/display portion indicates one or more real-time statuses, setting, instructions and/or other parameters to a user (and the roller assembly via a motor). It is noted that the interface/display portion may indicate the statuses and setting to the user visually, audibly, tactically or a combination thereof. In some exemplary embodiments, the interface/display portion may visually indicate status and/or instructions to a user via an LED display or panel and/or a graphical user interface (GUI) (e.g., an LCD or like screen). The status and/or instructions indicated to the user via the at least one interface facilitate a particular bedding-in process or method performed by the device/system and the user acting in concert. The bedding-in processes comprises a plurality of cycles of a braking operation and a subsequent cooling operation while the wheel is rotated via the roller assembly and at least some of the real-time operational statuses are indicated by the display portion of the at least one interface. The braking operations comprise the disc brake being activated by the user within a defined braking level for a braking timeframe, and the cooling operations comprising the disc brake not being activated by the user for a cooling timeframe.

In some embodiments of the device/system, the at least one controller (e.g., a high-level controller) may read or accept at least one user input that is input via at least one input portion or device of the at least one interface. The input device or portion and the display device or portion may be portions or aspects of a common interface, or the input device or portion and the display device or portion may be portions or aspects of separate and distinct interfaces. The at least one user input may be at least one operational parameter of the device/system, such as at least one operational parameter of the bedding-in process (e.g., a selection of a particular bedding-in process). For example, in some such embodiments, the at least one controller may store and execute pre-configured programs (e.g., Program A, B, and C), each defined by particular cycles of specific/differing braking and cooling operations.

In some embodiments, the at least one controller (e.g., a high-level controller) may comprise at least one input/output connector or adapter that facilitates the input and/or output of data with the at least one controller, such as for software and/or firmware installation and/or updates, diagnostics, maintenance and software enhancements. The at least one input/output connector or adapter may comprise a USB interface, for example. As another example, the at least one input/output connector or adapter may comprise a WiFi adapter, Bluetooth adapter or other wireless connection mechanism remote operation and monitoring of the device/system. For example, a WiFi adapter can connect the device/at least one controller to the internet/data cloud for (e.g., via a computer, smartphone, tablet or like digital or analog electronic device that is remote or physically separated from the device/at least one controller). Similarly, Bluetooth capability can allow wireless communication or operation of the device/at least one controller via a device. It is noted that the input/output connector or adapter may allow the at least one interface, or at least one input portion and/or at least one display portion thereof, to be remote or physically separated from the device/at least one controller. For example, a smartphone or tablet or other electronic device may be utilized or form part of the at least one interface, or at least one input portion and/or at least one display portion thereof, that communicates with the at least one controller that may be mounted to base of the bedding-in device.

In some embodiments, the at least one controller (e.g., a low-level controller) may be configured for operational control and sensor integration. For example, in some embodiments, the at least one controller (e.g., a low-level controller) may control the motor of the device/system and/or may receive input or signals from one or more electrical sensors and/or switches of the device/system. For example, the at least one controller (e.g., a low-level controller) may be configured to control the motor, such as via starter, such as to control the start/stop of the motor, acceleration of the motor, and motor direction, for example. In some such embodiments wherein the motor is an AC single-phase motor, for example, the starter may be a soft starter, and the at least one controller be configured to control the soft starter. In some other such embodiments wherein the motor is a three-phase motor, the starter may be an inverter, and the at least one controller be configured to control the inverter. As another example, one controller may receive commands from another controller, and execute such commands, regarding specified braking and cooling operations (e.g., timeframes thereof, number of cycles, etc.) of a particular bedding-in process/method selected or input by a user.

The at least one controller (e.g., a low-level controller) may also monitor a real-time braking level of a breaking operation (performed by a user) during a bedding-in process/method, and provide an indication to the user of the real-time braking level compared to a defined (e.g., predefined) braking level, such as a braking level defined according to a particular bedding-in process/method selected or input by a user. For example, the at least one controller may detect, monitor or measure the speed of rotation of a part/component of the roller assembly (the belt drive, for example) at least during a braking operation of a bedding-in process, and determine a real-time breaking level during a breaking operation by comparing the difference between the amount or degree that the detected speed of rotation differs (slows or decreases) from a setpoint or baseline speed of rotation of the roller assembly/wheel that is the rotational speed of the roller assembly with the wheel engaged with the roller assembly but a breaking operation is not being performed (such as prior to any breaking operations). The at least one controller may be configured to determine or set the baseline speed of rotation of the roller assembly/wheel at the outset of a particular bedding-in process during a calibration process wherein the at least one controller rotates the roller assembly with the wheel engaged with the roller assembly and the disc brake of the wheel not utilized/engaged by the user.

The at least one controller may also determine a real-time breaking level, and control the at least one user interface to indicate or display an indication of a real-time breaking level as compared to a defined (e.g., predefined) speed reduction amount or level (i.e., a defined reduction is speed being a defined breaking level) as a real-time status of the device/system. For example, the at least one controller may indicate if a real-time breaking level is greater than or less than, and an indication of the degree thereof, of the defined breaking level of a braking operation. The defined braking level/speed reduction amount may be a set braking level throughout all bedding-in processes and/or all braking operations of a particular bedding-in process, or may differ from bedding-in processes or between braking operations of a particular bedding-in process.

In some embodiments, the device/system may detect, monitor, measure or otherwise determine the speed of rotation (or other movement) of a part/component of the roller assembly, such as to determine the speed of rotation of a wheel engaged and rotated via the roller assembly (prior to a braking operation, during a breaking operation, during a cooling operation, etc.). For example, in some embodiments the device/system may detect, monitor, measure or otherwise determine the speed of rotation of the roller assembly (and thereby a wheel engaged therewith) via a magnetic-field sensor that detects the presence of a magnetic marker or member that is coupled to a portion of a pulley or belt of the roller assembly to determine the time of a round-trip of the marker or member. However, in some other embodiments, the device/system may detect, monitor, measure or otherwise determine the speed of rotation (or other movement) of the roller assembly via detecting, monitoring or measuring a component or part of the device/system that is not a component or part of the roller assembly. For example, the device/system may detect, monitor, measure or otherwise determine the speed of rotation of the motor, such as directly detecting the motion of a component of the motor or indirectly by determining the voltage or current draw of the motor. In some other embodiments, the movement or speed of rotation of a wheel engaged with the roller is detected, monitored, measured or otherwise determined.

In some embodiments, the least one controller may indicate a plurality of real-time statuses of the device/system to a user via the at least one user interface. For example, as noted above, the at least one controller and the at least one user interface may indicate to the user a real-time brake level compared to the defined braking level during a braking operation. As another example, the at least one controller and the at least one user interface may provide an indication to the user to perform a breaking operation, and an indication to the user to perform a cooling operation after a breaking operation. In yet another example, the at least one controller and the at least one user interface may, during a braking operation, provide an indication to the user of a real-time status of an amount of time remaining in the braking timeframe of the braking operation. Similarly, the at least one controller and the at least one user interface may, during a cooling operation, provide an indication to the user of a real-time status of an amount of time remaining in the cooling timeframe of a cooling operation.

The at least one controller may also receive sensor data, signals or statuses of one or more sensors and/or switches to determine or obtain additional operational parameters of the system/device. For example, in some such embodiments, the at least one controller may read a wheel sensor of the system/device that senses the presence or absence of a wheel within the opening of the base and engaged with the roller assembly. In some such embodiments, the wheel sensor may be a touch-less sensor, such as an infrared sensor that comprises an infrared (IR) light-emitting module positioned on one side of the opening of the base that emits an infrared light beam, and an infrared (IR) light-detecting module positioned on another (e.g., opposing) side of the opening of the base that receives the emitted infrared light beam. The infrared sensor may be configured such that when the infrared light beam is obstructed by the insertion of a wheel in the opening and positioned on the rollers of the roller assembly, the detecting module informs the at least one controller (e.g., a low level controller) accordingly (and the at least one controller may enable appropriate motor and system responses based thereon, for example). As another example, in some embodiments, the at least one controller may read a rotation direction control switch, and control the direction of rotation of the motor, and thereby the roller assembly, that corresponds to the direction of rotation of a front wheel or a rear wheel of a cycle when inserted into the opening of base with the cycle facing forward or backward, respectively. In yet another example, some embodiments, the at least one controller may read a temperature sensor associated with the motor as a safety function to prevent overheating or damage of the motor.

In some embodiments, the at least one controller may comprise a plurality of controllers, such as but not limited to at least one high-level controller and at least one low-level controller. The plurality of controllers may be electrically coupled (e.g., via wiring) and/or wirelessly coupled and communicate with each other. For example, in one exemplary embodiment, the device/system may include a first controller (e.g., a high-level controller) that communicates with a second controller (e.g., a high-level controller) for data exchange and coordination of the operations thereof, such as via a robust RS485 data interface.

In some embodiments of the system/device, the system/device may further comprise a motor starting component configured to enable precise control of the motor (e.g., an AC single-phase motor) and ensures operational stability. The motor starting component may control the motor using solid-state switches for reliable and efficient operation. For example, the motor starting component may comprise a control switch for motor acceleration that increases current in an AUX winding of the motor when starting under high-load conditions. As another example, the motor starting component may control motor rotation direction by switching the supply voltage between MAIN and AUX windings of the motor in specific combinations, allowing bidirectional movement of the motor (and thereby the roller assembly and wheel of a cycle engaged therewith).

In another aspect, the present disclosure provides a method for bedding-in disc brakes for cycles, such as bicycles, using a bedding-in system/device comprising: detecting whether a cycle wheel with an associated disc brake is inserted into an opening of a base of the system/device and engage with a roller assembly thereof; generating a signal confirming wheel presence; initiating a bedding-in process program stored in a controller of the system/device or input into the system/device, based on a user input based corresponding to components of the associated disc brake; performing a calibration wherein the wheel is rotated via the roller assembly and a baseline rotation speed of the roller assembly is determined; and performing intervals of braking operations at a suitable braking load and cooling operations for designated time periods, wherein during the braking operations the at least one controller operates a user interface to indicate a braking operation indication to instruct the user to manually apply the disc brake associated with the wheel, wherein after concluding each braking operation, the at least one controller operates the user interface to indicate a cooling operation indication to instruct the user to instruct the user to not apply the disc brake associated with the wheel.

In some embodiments, the at least one controller may be configured to monitor the roller assembly and/or motor to determine slippage of the wheel with the roller assembly, and pause or stop a bedding-in process/method being performed if wheel slippage (or wheel removal/disengagement) is detected. In some such embodiments, the at least one controller may be configured store the status of the bedding-in process/method such that a paused or stopped bedding-in process/method can be restarted from the point of interruption after the wheel slippage has stopped (or the wheel is re-inserted or engaged).

In some embodiments of the method, the at least one controller manages the operation of the system/method during the braking and cooling operations, such as operating the user interface accordingly to provide the user with real-time instructions and/or information regarding an active/current braking or cooling operation. For example, the at least one controller may be configured to control the user interference such that the user interface provides an indication to the user to perform a breaking operation for the breaking timeframe and an indication of a real-time status of the breaking timeframe, while operating the motor accordingly and monitoring the wheel presence sensor to ensure the wheel is engaged with the roller assembly. As another example, at the expiration of a braking timeframe, the at least one controller may be configured to control the user interference such that the user interface no longer provides the indication to the user to perform the braking operation and instead provides an indication to the user to perform a cooling operation for the cooling timeframe and an indication of a real-time status of the cooling timeframe, while operating the motor accordingly and monitoring the wheel presence sensor to ensure the wheel is engaged with the roller assembly. As another example, the at least one controller may be configured to control the user interference such that the user interface provides an indication of the status of the progress of a current bedding-in process/method being performed by the system/device (e.g., an indication of the number of completed braking and cooling cycles as compared to the total number of cycles of the current bedding-in process/method being performed).

In some embodiments of the method, the method performs a bedding-in method/process according to a bedding-in process/method or mode that the user selects or inputs. For example, the at least one controller may comprise a plurality of different bedding-in processes/methods saved or stored therein (e.g., in memory thereof), the plurality of different bedding-in processes/methods differing in the number of braking and cooling operation cycles and/or differing in the braking and/or cooling timeframes. In some such embodiments, the at least one controller may comprise at least first, second and third differing bedding-in processes/methods saved or stored therein. For example, the first bedding-in process/method may comprise six braking and cooling cycles with the braking timeframes each being a first timeframe (e.g., 15 seconds) and the cooling timeframes each being a second timeframe (e.g., 10 seconds), the second bedding-in process/method may comprise six braking and cooling cycles with the first three braking timeframes each being a first timeframe (e.g., 15 seconds) and the subsequent three braking timeframes each being a second timeframe (e.g., 20 seconds), and the cooling timeframes each being a third timeframe (e.g., 10 seconds), and the third bedding-in process/method may comprise six braking and cooling cycles with the first two braking timeframes each being a first timeframe (e.g., 15 seconds) and the subsequent four braking timeframes each being a second timeframe (e.g., 20 seconds), and the cooling timeframes each being a third timeframe (e.g., 10 seconds). It is noted that the first, second and third bedding-in processes/methods may be particularly well suited for bedding-in different cycle disc brake configurations or designs. For example, the first bedding-in process/method being partially well suited for bedding-in disc brakes with about 140 mm to about 160 mm rotors (ice-tech type, Shimano brand) with two piston calipers, or with about 180 to about 203 mm regular rotors with brake caliper with four pistons, the second bedding-in process/method being partially well suited for bedding-in disc brakes with about 160 mm to about 180 mm rotors (ice-tech type, Shimano brand) with two piston calipers, or with about 180 to about 203 mm regular rotors with brake caliper with four pistons, and the third bedding-in process/method being partially well suited for bedding-in disc brakes with about 180 mm and larger rotors (ice-tech type, Shimano) with two piston calipers, or with about 203 mm and larger rotors regular rotors with brake caliper with two or four pistons.

It should be appreciated that all combinations of the foregoing aspects and additional concepts discussed in greater detail below (provided such concepts are not mutually inconsistent) are contemplated as being part of the inventive subject matter and to achieve the advantages disclosed herein.

Additional features are realized through the further description and disclosure of the cycle disc brake bedding-in systems and methods disclosed herein. Other examples and aspects are described in detail herein. The foregoing and other objects, features and advantages of the invention will be apparent from the following more detailed descriptions of particular embodiments of the cycle disc brake bedding-in systems and methods, as illustrated in the accompanying drawings wherein like reference numbers represent like features.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings, which may or may not be drawn to scale, in which:

FIG. 1 illustrates an exemplary hydraulic-type disc brake system of a wheel of a cycle, according to aspects described herein;

FIG. 2 illustrates an exemplary hybrid hydraulic-mechanical disc brake system of a wheel of a cycle, according to aspects described herein;

FIG. 3 illustrates a front perspective view of an exemplary cycle disc brake bedding-in system, according to aspects described herein;

FIG. 4 illustrates a front elevational perspective view of the exemplary bedding-in system of FIG. 3, according to aspects described herein;

FIG. 5 illustrates a rear perspective view of the exemplary bedding-in system of FIG. 3 with a side panel of a base of the bedding-in system removed, according to aspects described herein;

FIG. 6 illustrates a top view of the exemplary bedding-in system of FIG. 3, according to aspects described herein;

FIG. 7 illustrates an elevational perspective view of an exemplary roller assembly of the exemplary bedding-in system of FIG. 3, according to aspects described herein;

FIG. 8 illustrates a side view of the exemplary roller assembly of FIG. 7, according to aspects described herein;

FIG. 9 illustrates an elevational perspective view of the exemplary bedding-in system of FIG. 3 performing a bedding-in process of a disc brake of a wheel of an exemplary cycle, according to aspects described herein;

FIG. 10 illustrates a side view of the exemplary bedding-in system and cycle of FIG. 9 performing a bedding-in process of a cycle wheel, according to aspects described herein;

FIG. 11 illustrates a rear view of an exemplary bedding-in system and cycle of FIG. 9 performing a bedding-in process of a cycle wheel, according to aspects described herein;

FIG. 12 illustrates a side view of the exemplary bedding-in system of FIG. 3 incorporating an exemplary temperature sensor and an exemplary exhaust system, according to aspects described herein;

FIG. 13 illustrates a perspective view of another exemplary cycle disc brake bedding-in system with a remote user interface, according to aspects described herein;

FIG. 14 illustrates an embodiment of the remote user interface of the bedding-in system of FIG. 13, according to aspects described herein;

FIG. 15 illustrates another embodiment of the remote user interface of the bedding-in system of FIG. 13, according to aspects described herein; and

FIG. 16 illustrates a flow chart of a cycle disc brake bedding-in process, according to aspects described herein.

### DETAILED DESCRIPTION

The accompanying figures, in which like reference numerals refer to identical or functionally similar elements throughout the separate views and which are incorporated in and form a part of the specification, further illustrate the present implementation and, together with the detailed description of the implementation, explain the principles of the present implementation. As understood by one of skill in the art, the accompanying figures are provided for ease of understanding and illustrate aspects of certain examples of the present implementation. The implementation is not limited to the examples depicted in the figures.

The terms “coupled”, “affixed”, “connected” and the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “coupled to” the another component, for example, is somehow in operative communication (e.g., electrically, physically, optically, etc.) with the other component (notwithstanding the presence of one or more additional components therebetween). Accordingly, one component being “coupled to” another component may or may not be direct physical contact with each other.

The terms “including” and “comprising”, as used herein, mean the same thing. The terms “substantially”, “approximately”, “about”, “relatively”, or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. If used herein, the terms “substantially”, “approximately”, “about”, “relatively,” or other such similar terms may also refer to no fluctuations, that is, ±0%.

Terminology used herein is for the purpose of describing particular examples only and is not intended to be limiting. As used herein, the singular forms “a”, “an” and “the” are intended to include the plural forms as well, unless the context clearly indicates otherwise. Furthermore, references to “one example” are not intended to be interpreted as excluding the existence of additional examples that also incorporate the recited features. Moreover, unless explicitly stated to the contrary, the terms “comprising” (and any form of “comprise,” such as “comprises” and “comprising”), “have” (and any form of “have,” such as “has” and “having”), “include” (and any form of “include,” such as “includes” and “including”), and “contain” (and any form of “contain,” such as “contains” and “containing”) are used as open-ended linking verbs. As a result, any examples that “comprises,” “has,” “includes” or “contains” one or more step or element possesses such one or more step or element, but is not limited to possessing only such one or more step or element. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable or suitable.

Reference is made below to the drawings, which may or may not be drawn to scale, for ease of understanding, wherein the same reference numbers are used throughout different figures, in some cases, to designate the same or similar components. The following description of certain examples will be better understood when read in conjunction with the appended drawings.

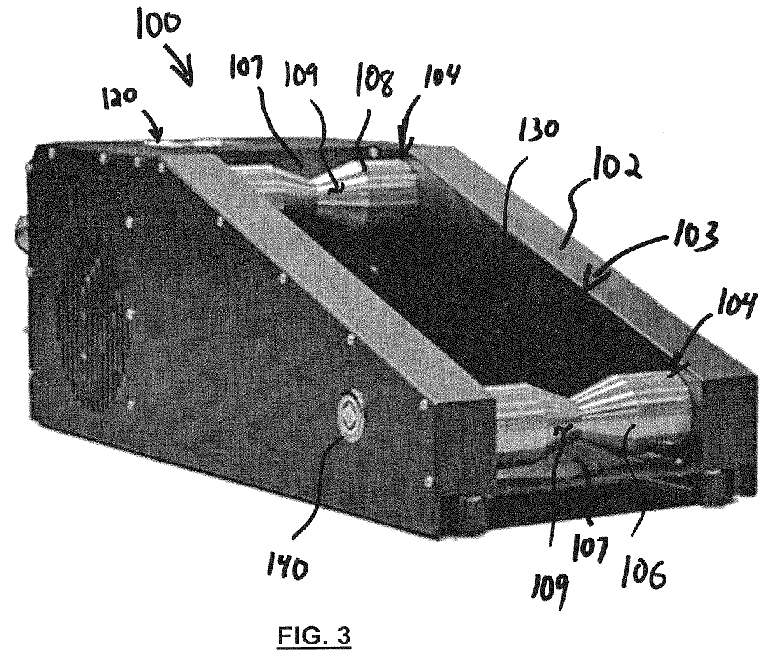

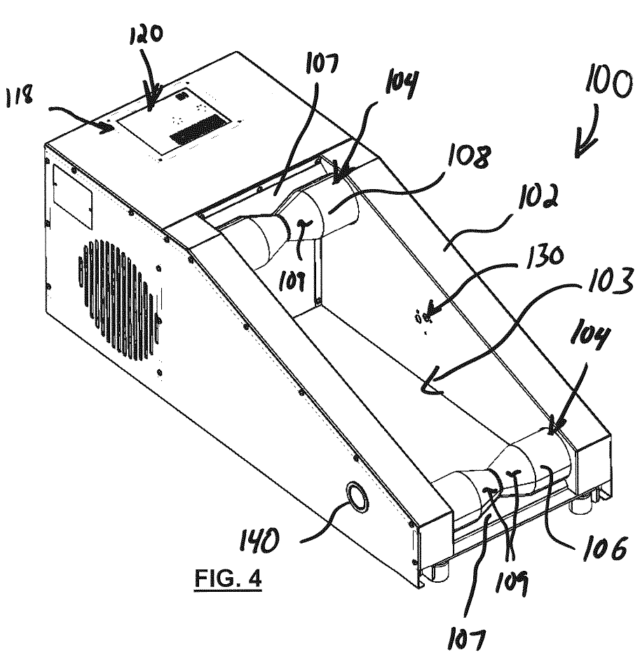

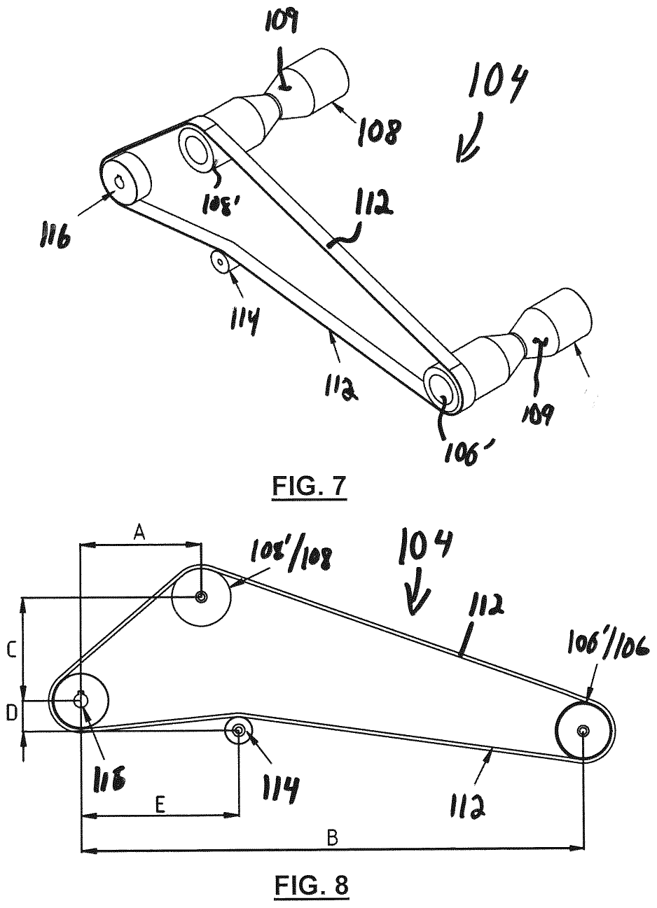

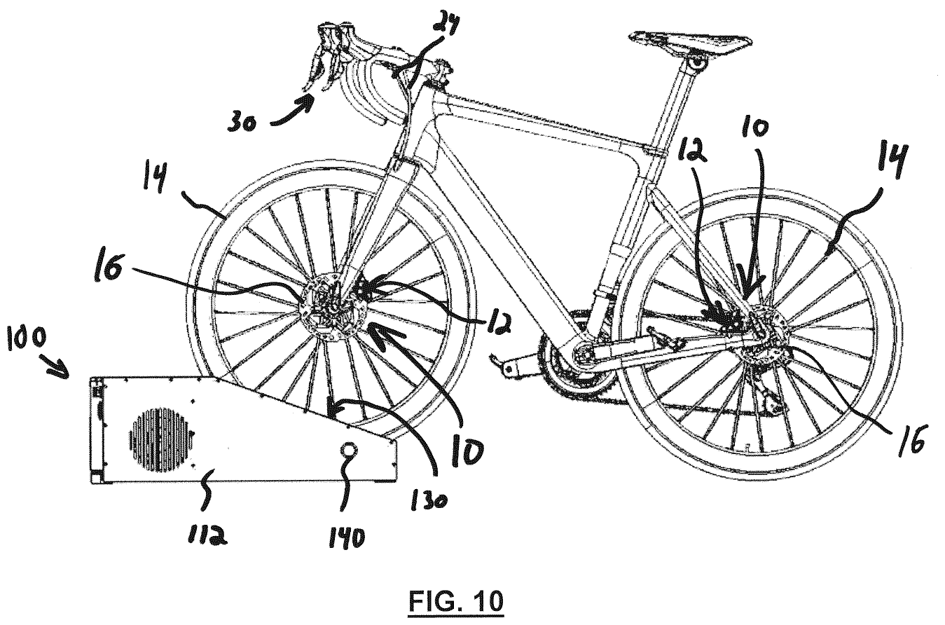

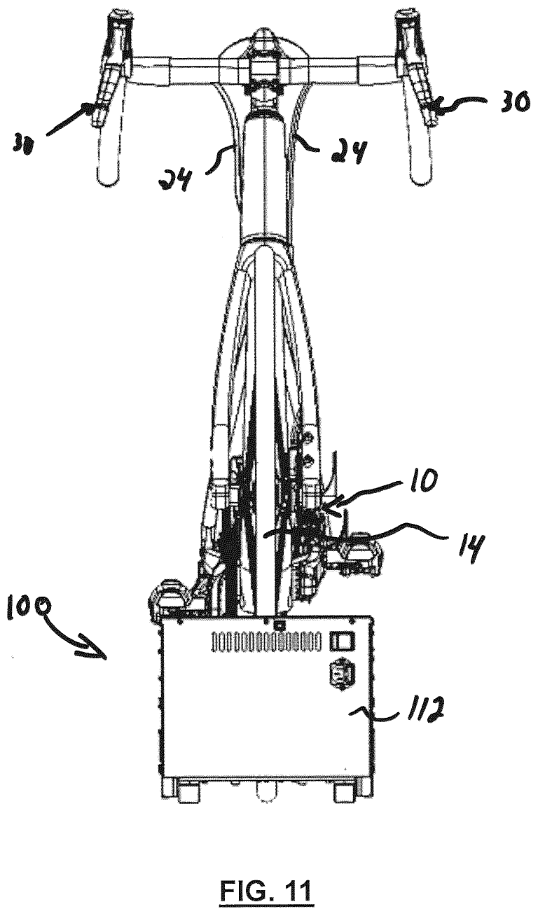

FIGS. 3-12 illustrate an exemplary embodiment of cycle (e.g., bike) disc brake bedding-in system (or device) 100, and related cycle (e.g., bike) disc brake bedding-in methods utilizing the bedding-in system 100, according to the present disclosure. As shown, the bedding-in system 100 provides a controlled and user-guided process for bedding-in disc brakes of a cycle (e.g., bikes), which produces increased brake pad/brake performance and safety as compared to not bedding-in the disc brakes and/or bedding-in the disc brakes via traditional processes (e.g., a typical parking-lot bedding-in process), a consistent brake feel, instant brake power, and requires only minimal labor. The bedding-in system 100 produces an even, consistent and compositionally correct transfer layers on the rotor surfaces, resulting in superior braking performance and wear of the disc brakes over their lifespan. For example, the bedding-in system 100 does not produce “hotspots” on the pad or rotor surfaces that are often formed with current bedding-in system/methods, leading to quiet and uniform braking performance.

The bedding-in system 100 produces improved braking performance (e.g., coefficients of friction) both initially and over time (e.g., over many brake cycles, such as over hundreds of brake cycles) as compared to prior bedding-in system/methods, such as brake performance increases of at least about 20%. The bedding-in system 100 produces initial friction benefits that continue over the lifespan of the disc brakes (e.g., the lifespan of the brake pads thereof).

The bedding-in system 100 reduces the time and costs of cycle disc brake bedding-in as compared to prior cycle disc brake bedding-in systems and processes. For example, the bedding-in system 100 utilizes minimal processing/procedure time, and produces high quality, consistently bedded-in cycle disc brakes indoors within a small physical footprint.

With continued reference to FIGS. 3-12, in some embodiments the bedding-in system 100 may comprise a base or housing 102 that forms an opening 103, and a roller assembly 14 that comprises at least two rollers 106, 108 which extend within the opening 103 and are rotatably coupled or mounted with the base 102.

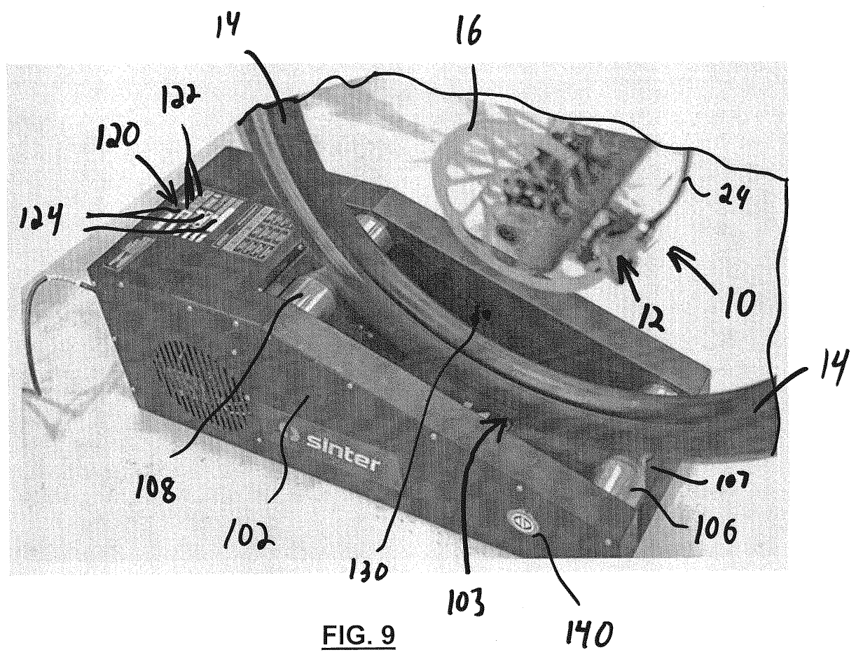

As described further below, and shown in FIGS. 9-12, the base 102 and the rollers 106, 108 are configured such that the opening 103 is configured to accept one wheel (e.g., a singular wheel) of a cycle (e.g., a bicycle wheel) that includes a disc brake system 10 therein with the wheel 14 being physically supported by (or engaged with) the rollers 106, 108. The opening 103 and the rollers 106, 108 may thereby be sized and shaped (e.g., width and length) to receive the wheel 14 of the cycle. For example, the opening 103 and the rollers 106, 108 may be sized and shaped to receive a bicycle wheel ranging from about 20 inches to about 32 inches in diameter, and up to about 6 inches in width or about 3 inches in width, for example.

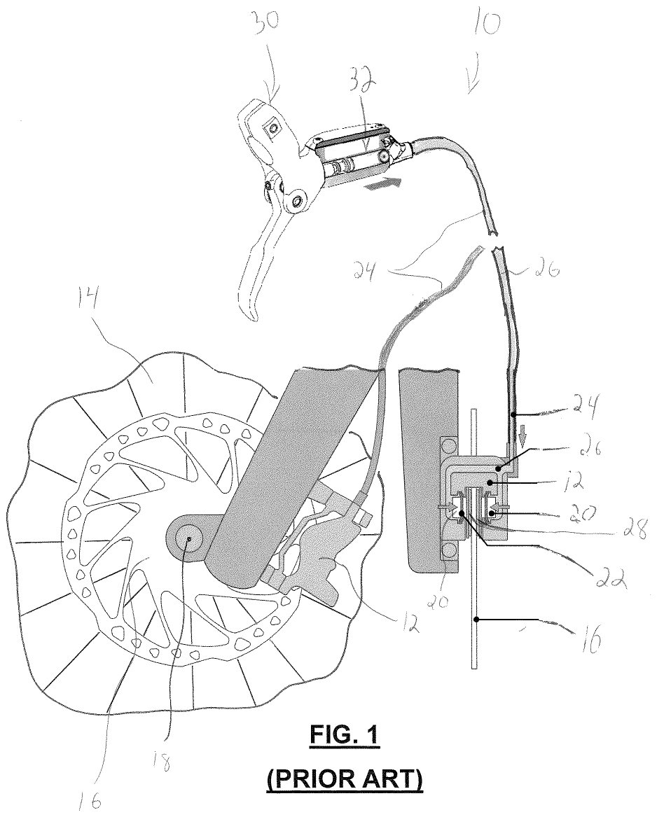

As also explained further below, the bedding-in system 100 is configured such that at least one of the rollers 106, 108 rotatably drives the wheel 14 during a bedding-in method or process that beds-in the disc brake system 10 associated with the wheel 14 while maintaining stable wheel/tire 14 engagement and efficient operation of the system 100 and the disc brake system 10. The disc brake system 10 may comprises a brake rotor 16 fixed to the wheel 14 of the cycle and a pair of brake pads 28 mounted on a caliper 12 that selectively compresses against the brake rotor 16 via operation of a brake handle/mechanism 30 while the wheel 14 and rotor 16 are rotating during a braking operation of the disc brake system 10 to slow and/or stop the rotation of the wheel 14, as described above and shown in FIGS. 1, 2 and 9-12.

In some embodiments, the base 102 may comprise a framework and/or frame members, a plurality of panels, brackets and/or other structural components that form a stand-alone device or appliance that physically and operably supports other components of the bedding-in system 100, as shown in FIGS. 3-6 and 9-12. The base 102 may be sized and shaped such that the bedding-in system 100 defines a small footprint which can be easily utilized indoors in a workshop, sales floor, showroom or backroom or the like. The base 102 may be configured to rest on a floor (e.g., via non-slip feet) with the opening 103 exposed on the top and/or front sides of the base 102, and retain a wheel 14 of a cycle within the opening 103 and on the roller 106, 108 (and rotate the wheel 14) without tipping over or translating along the floor.

For example, in some exemplary embodiments, the base 102 may comprise an inner framework and a plurality of outer panels. The plurality of outer panels may include a base panel, two lateral outer side panels that define the lateral sizes of the base 102, and two inner lateral side panels that define the opening 103 arranged to receive the wheel 14 of the cycle (e.g., bicycle). The rollers 106, 108 may extend between the inner side panels, and be positioned above (spaced from) the base panel. The plurality of outer panels may also include a front or top panel covering a part of the base 102 behind the opening 103 (the front panel being and the base panel being horizontal and parallel to each other in some embodiments), and a middle panel extending along a height of the base 102 between the base and top panels and the inner side panels. The middle panel may form the back of the opening 103, and may separate the opening 103 from an enclosed space within the base 102 under the front panel behind the middle panel and between the outer side panels. The plurality of outer panels may further include a back panel that forms the back of the base 102. The back panel, middle panel and the two lateral outer side panels may thereby form the enclosed space within the base 102, which may house electrical and/or mechanical components of the system 100. In some embodiments, a power cord, socket or plug, on/off switch, fuse panel, fan and fan cover/vent, input and/or output ports or other electrical/electro-mechanical components may be mounted to one of the plurality of outer panels, such but not limited to the back panel, the outer side panels, the inner side panels and the top panel.

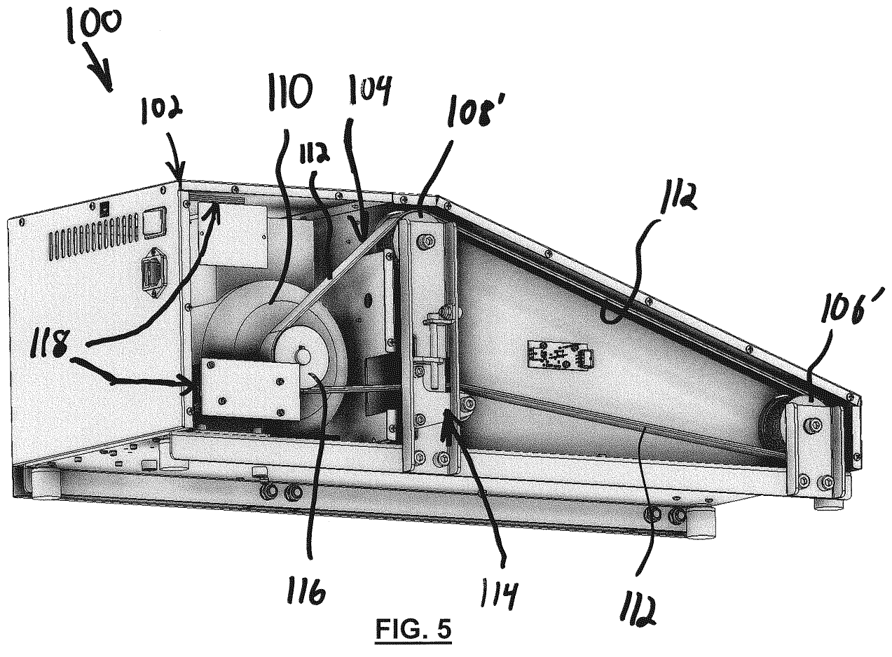

As shown in FIG. 5, the bedding-in system 100 may further comprise at least one electric motor 116 mounted to the base 102, such as within an interior area of the base 102, operatively coupled with the roller assembly 104 configured to rotate at least one of the rear and front rollers 108, 106 to rotate the wheel 14 (and thereby the rotor 16) of a cycle. The at least one motor 116 may be any controllable electric motor or the like that is capable of producing a torque sufficient to rotate at least one of the rear and front rollers 108, 106 to rotationally drive the wheel 14 (and thereby the rotor 16) of the cycle. It is noted that the motor 116 may include control electronics, wiring, temperature management devices, sensors, starting components and other related components for the operation of the motor 116, and thus comprise a motor system. For example, the motor 116 may include a motor starting component configured to enable precise control and ensure operational stability of the motor 116 (e.g., of an AC single-phase motor). A motor starting component or other control mechanism of the motor 116 may be configured to control the motor 116 using switches (e.g., solid-state switches), increase current (e.g., in an AUX winding of the motor 116) when starting and/or under high-load conditions, and/or control the direction of rotation of the motor 116 switching a supply voltage between windings (e.g., between the MAIN and AUX windings) in specific combinations, allowing bidirectional selective/controllable rotation of the motor 116.

The motor 116 may be operatively coupled with at least one of the front and rear rollers 106, 108 to drive/rotate the roller, and thereby a wheel 14 and rotor 16 coupled thereto, via the roller assembly 104. In some embodiments, such as the illustrative embodiment of the bedding-in system 100, the roller assembly 104 is configured such that the motor 116 operatively drives/rotates/torques both of the front and rear rollers 106, 108. Both of the front and rear rollers 106, 108 being drive rollers, such that they are driven by the motor 116 and operatively drive a cycle wheel 14 engaged therewith during a bedding-in process, ensures that the wheel 14 (and rotor 16 coupled thereto) is constantly driven via the rollers as it will be in constant contact with at least one of the front and rear rollers 106, 108, and ensures smooth rotation/torque of the wheel 14 and compensates for variations in different wheel sizes, vibration and other factors that may cause one of the front and rear rollers 106, 108 to slip or become disengaged from the wheel 14. Both of the front and rear rollers 106, 108 being drive rollers may also more effectively and efficiently rotate a wheel 14, and/or more stably engage and drive rotation of the wheel 14, as compared to if one of the front and rear rollers 106, 108 was driven by the motor 116.

As shown best in FIGS. 5, 7 and 8, in some embodiments, the roller assembly 104 may comprise a belt, chain or gear drive 112 that operatively couples the motor 116 and at least one of the front and rear rollers 106, 108. The belt drive 112 may thereby extend between the motor 116 and at least one of the front and rear rollers 106, 108. In some embodiments, as shown, the belt drive 112 may be operatively coupled to both of the front and rear rollers 106, 108 (and the motor 116) such that the motor 116 drives both of the front and rear rollers 106, 108 (i.e., both of the front and rear rollers 106, 108 are drive rollers). The belt drive 112 may thereby extend between the motor 116, the front roller 106 and the rear roller 108. In such embodiments, the belt drive 112 effectuates synchronized rotation of the front and rear rollers 106, 108, which may ensure smooth operation and constant contact of the rollers 106, 108 with the wheel/tire 14.

In some such embodiments, the roller assembly 104 may further comprise a tensioner 114, as shown in FIGS. 5, 7 and 8. The tensioner 114 may be operatively coupled with the belt drive 112, and configured to maintain appropriate tension in the belt drive 114, such as to compensate for variations in component positions (e.g., roller positions, belt lengths/stretching, etc.) and/or different wheel sizes. As shown in FIG. 5, the tensioner 114 may selectively be translated into the pathway or position of the belt drive 112 as it extends between the motor 116 and at least one of the front and rear rollers 106, 108 such that the tensioner 114 engages the belt drive 112 and varies the pathway of the belt drive 112 as it extends between the motor 116 and at least one of the front and rear rollers 106, 108. The tensioner 114 may thereby lengthen or shorten the pathway of the belt drive 112, and thereby increase or decrease, respectively, the tension of the belt drive 112. In some embodiments, the tensioner 114 is in a fixed position relative to the belt drive 112 that functions effectively to tension the belt drive 112 across a range of cycle wheel sizes by maintaining a consistent belt path.

With continued reference to FIGS. 5, 7 and 8, in some such embodiments, the roller assembly 104 may also comprise a driving pulley 116 that is rotationally fixedly coupled with the motor 116 and operatively coupled with the belt drive 112 to transmits the rotational power from the motor 116 to the belt drive 112. For example, the driving pulley 116 may be affixed on a drive shaft of the motor 116. Similar to the driving pulley 116, the front roller 106 and the rear roller 108 may include a respective pulley 106′, 108′ that operatively coupled the rollers 106, 108 and the belt drive 112, as shown in FIGS. 5, 7 and 8. The front roller pulley 106′ may thereby be rotationally fixedly coupled with the front roller 106 (such as affixed to an end thereof or formed by an end portion thereof), and the rear roller pulley 108′ may thereby be rotationally fixedly coupled with the rear roller 108 (such as affixed to an end thereof or formed by an end portion thereof). The driving pulley 116, the front roller pulley 106′ and the rear roller pulley 108′ may thus transmit the rotation/power/torque of the motor 116 to the front and rear rollers 106, 108 via the belt drive 112. The driving pulley 116, the front roller pulley 106′ and the rear roller pulley 108′ may be configured to maintain non-slip connection with the belt drive 112 during rotation.

In some embodiments of the bedding-in system, the rear roller 108 (and the rear roller pulley 108′), the front roller 106 (and the front roller pulley 106′), the belt drive 112, the drive tensioner 114 and the driving pulley 116 (and the motor drive shaft) are spatially arranged by distances A, B, C, D, and E between the axis of rotations (or axels) thereof, as shown in FIG. 8. In some embodiments, distance A is a horizontal spacing between the rear roller 108 (and the rear roller pulley 108′) and the driving pulley 116 (and the motor drive shaft). Distance A can be configured/dimensioned to ensure the rear and front rollers 108, 106 can effectively engage cycle wheels/tires of relatively large diameters, such as diameters up to about 36 or 32 inches, by positioning the roller assembly 104 high enough within the opening 103 for wheel-base clearance. In some embodiments, distance A is within the range from about 10 to about 150 mm. In some embodiments, distance B is a horizontal spacing between the front roller 106 (and the front roller pulley 106′) and the tensioner 114. Distance B can be configured/dimensioned to ensure the tensioner effectively maintains tension in the belt drive 112 while accommodating smaller wheel sizes, such as wheel as small as about 20 inches. In some embodiments, distance B is within the range from about 250 to about 550 mm. In some embodiments, distance C is a vertical spacing between the rear roller 108 (and the rear roller pulley 108′) and the driving pulley 116 (and the motor drive shaft). Distance C can be configured/dimensioned to accommodate varying wheel/tire radii/diameters/sizes from smaller wheels to larger wheels without compromising the alignment of the belt drive 112. In some embodiments, distance C is within the range from about 80 to about 150 mm. In some embodiments, distance D is a vertical distance between the front roller 106 (and the front roller pulley 106′) and the driving pulley 116 (and the motor drive shaft). Distance C is configured/dimensioned to ensure that a wheel/tire 14 of a cycle rests in contact with both rollers 106, 108 irrespective of its size. In some embodiments, distance D is within the range from about 20 to about 80 mm. In some embodiments, distance E is a horizontal distance between the driving pulley 116 (and the motor drive shaft) and the tensioner 114. Distance E can be configured/dimensioned to allow the tensioner 114 to function effectively across the entire range of wheel sizes by maintaining a consistent pathway of the belt drive 112. In some embodiments, distance E is within the range from about 10 to about 180 mm.

In some embodiments, a straight line distance and vertical height between the axis of rotation of the front roller 106 (and the front roller pully 106′) and the rear roller 108 (and the rear roller pully 108′) (or a straight line distance and height distance between wheel engagement surfaces 109 of the rollers 106, 108) is configured to allow the system 100 to operate with cycle (e.g., bicycle) wheels ranging from about 20 inches to about 32 inches in diameter while maintaining stable wheel/tire engagement and efficient operation. In some such embodiments, such a straight-line distance between the front and rear rollers 106, 108 may be within the range of about 12 inches to about 20 inches, or preferably within the range of about 14 inches to about 18 inches, such as about 16 inches. In some embodiments, such a vertical height distance between the front and rear rollers 106, 108 may be within the range of about 3 inches to about 8 inches, or preferably within the range of about 4 inches to about 7 inches, or more preferably within the range of about 5 inches to about 6 inches. In some embodiments, a horizontal or depth distance (a direction extending front to back) between the front and rear rollers 106, 108 may be within the range of about 11 inches to about 19 inches, or preferably within the range of about 13 inches to about 17 inches, such as about 15 inches.

The roller assembly 104 provides a versatile solution for supporting a wide range of sizes of cycle (e.g., bicycle) wheels 14. The integration of specific dimensional relationships between the rollers 106, 108, and the profiles of the rollers 106, 108, ensure stability, adaptability, and consistent operation for cycle wheels/tires 14 of varying diameters and widths. For example, with smaller wheels 14 (e.g., wheels 14 of 20 inches in diameter), shorter wheel radius positions the wheel 14 lower in the roller assembly 104, but the configuration of the roller assembly 104 ensures that the wheel 14 maintains stable contact with the both rollers 106, 108 while the tensioner 114 compensates for the reduced distance in the pathway of the belt drive 112. With larger wheels 14 (e.g., wheels 14 of 19 inches in diameter), the longer radius of the wheel 14 positions the wheel 14 higher in the roller assembly 104, but the relatively large horizontal and vertical distances between the drive pulley 116 (and motor drive shaft) and the rear roller 108 (and rear roller pulley 108′) ensure adequate clearance of the wheel 14 in the opening 13, while the profiles of the rollers 106, 108 provide centering and lateral stability.

For example, the rear roller 108 may be positioned proximate to the rear/back of the opening 103, the front roller 106 may be positioned proximate to a front part of the opening, and the rear roller 108 may be positioned higher than the front roller 106, as shown in FIGS. 3, 4, 6 and 9. The rear roller 108 may thereby be a rear upper roller 108, and the front roller 106 may be a front lower roller 106. It is noted that the rollers 106, 108 may be in fixed positions with respect to each other and with respect to the base 102 (fixedly mounted with the base 102), as shown in the illustrated exemplary embodiment. However, in alternative embodiments, the rollers 106, 108 may be in adjustable positions with respect to each other (at least one roller 106, 108 may be movable with respect to the other roller 106, 108) and with respect to the base 102 (at least one roller 106, 108 may be movably mounted with the base 102).

Further, both the front and rear rollers 106, 108 may comprise a cross-sectional size and/or shape, along its axial length, configured to retain engagement with a wheel 14. In some embodiments, the front roller 106 and the rear roller 108 each comprise a wheel engagement portion, area or surfaces 109 of reduced diameter configured to engage and retain the wheel 14 of the cycle thereon during the bedding-in process. In some embodiments, the reduced diameter wheel engagement portions 109 include flanged or angled surface portions that extend radially inwardly toward the axis of rotation as they extend axially or longitudinally toward each other. For example, in some such embodiments, the wheel engagement portion 109 of each of the front roller 106 and the rear roller 108 has a concave profile along its outer circumferential surface that includes angled (radially and longitudinally extending) side portions (e.g., conical surface portions) that form an angle therebetween (or with respect to the respective axis) within the range of about 100 degrees and about 160 degrees (e.g., about 140 degrees).

In some embodiments, the wheel engagement portion 109 of each of the front roller 106 and the rear roller 10 may include a circumferentially flat central or middle portion (of a constant diameter as it extends axially) extending axially between the angled/flanges portions. The central portion of the wheel engagement portion 109 of each of the front roller 106 and the rear roller 108 may thereby define a reduced diameter relative to the angled portions. In an exemplary embodiment thereof, the each of the front roller 106 and the rear roller 10 may define a circular cross-section adjacent to the wheel engagement portion 109 wheel engagement portion 109 of a first diameter, and the central reduced diameter portion of the wheel engagement portion 109 thereof may define a circular cross-section of a second diameter that is about half of the first diameter (with the angles surface portions extending axially and radially therebetween). As an example, the first diameter may be within the range of about 45 mm to about 75 mm (e.g., about 60 mm), and the second diameter may be within the range of about 40 mm to about 20 mm (e.g., about 30 mm).

The configuration (e.g., geometry of the outer surfaces) of the wheel engagement portion 109 of each of the front roller 106 and the rear roller 108 ensures a stable engagement of the each of the front roller 106 and the rear roller 108 with a wheel 14 of a cycle irrespective of its size (diameter) or width. The wheel engagement portions 109 are configured to automatically center the wheel 14 during operation/rotation, mitigating lateral displacement, and provide continuous and uniform contact with the wheel 14 regardless of its width. The angled/flange portions of the wheel engagement portions 109 may be optimized to prevent the wheel 14 from slipping laterally/axially/longitudinally off the respective roller 106, 108 during rotation and to allow the roller 106, 108 to accommodate a range of widths of cycle wheels 14 (e.g., from narrow road tires less than about 1-½ inches to wide mountain bike tires up to about 3 or 4 inches). For example, concave surface of the engagement portions 109 allows narrow wheels 14 to engage the central region, while wider wheels 14 are supported by the angled flanged portions near the edges.

In some embodiments of the bedding-in system 100, as shown in FIGS. 3, 4, 6, 9 and 13, the system 100 includes roller protectors 107 that extend between the base 102 and each of the front roller 106 and the rear roller 108 to prevent or mitigate the potential of a body part or other object (e.g., clothing) from becoming trapped and/or squeezed between the rollers 106, 108 and the base 102 (and potentially wrapped around the rollers 106, 108). The roller protectors 107 may extend from a panel that is adjacent (e.g., below or underneath) the rollers 106, 108 to proximate to the respective roller 106, 108, as shown. The roller protectors 107 may extend along the entire (axial) lengths of the rollers 106, 108, and define a profile that mirrors, matches or corresponds to the profile of the rollers 106, 108. The roller protectors 107 may thereby extend right up to the rollers 106, 108 and form a very small gap or space there-between. In some embodiments, a shown, the system 100 may include a roller protector 107 that extends between a front bottom portion or panel and a front bottom portion of the first roller 106, and a roller protector 107 that extends between a rear top portion or panel of the base 102 and a rear top portion of the rear roller 108.

As shown in FIGS. 3-6 and 9, the bedding-in system 100 comprises at least one user interface 120 comprising at least one display portion 124 that provides one or more indications to a user, and at least one input interface portion 122 that inputs at least one operational parameter or other information via user interaction, and at least one controller 118 that monitors real-time operational statuses of the system 100, and controls the electric motor 116 and the at least one user interface 120, based on the at least one operational parameter input by the input interface portion 122 and the real-time operational statuses, to execute a bedding-in process that beds-in the disc brake 10 of the wheel 14 of the wheeled cycle (e.g., bicycle). The bedding-in process comprises a plurality of cycles of a braking operation and subsequent cooling operation while the wheel 14 is rotated via the roller assembly 1045 (i.e., the front and rear rollers 106, 108) and at least some of the real-time operational statuses are indicated by the display portion 124. As noted herein, a braking operation comprises the disc brake 10 being activated by a user (e.g., via a handle or activation mechanism 30) within a defined braking level for a braking timeframe, and a cooling operation comprises the disc brake 10 not being activated by the user for a cooling timeframe. At least some of the real-time operational statuses may be indicated by the display portion 124 during the bedding-in process to instruct the user to operate the disc brake 10 in accordance with the braking and cooling operations. As discussed further below, the real-time operational statuses that are indicated by the display portion 124 during a bedding-in process can include an indication to the user to perform a first braking operation, an indication to the user of a real-time brake level compared to the defined braking level during the first braking operation, and an indication to the user to perform a first cooling operation after the first braking operation, an indication to the user to perform an N^{th} braking operation after the first cooling operation, an indication to the user of a real-time brake level compared to the defined braking level during the N^{th} braking operation; and an indication to the user to perform an N^{th} cooling operation after the N^{th} braking operation.

In some embodiments of the bedding-in system 100, the at least one user interface 102 may be a local user interface that is mounted or coupled (fixedly or removably) on the base 102 and operatively coupled with the at least one controller 118 via a physical electrical connection (e.g., via wiring), as shown in FIGS. 3-6 and 9. For example, at least one interface of the at least one user interface 102 may be mounted on a top portion or panel of the base 102 such that a user using the system 100 is within line of sight when operating the system 100 and the disc brake system 10 of wheel 14 of a cycle (e.g., bicycle) engaged with the roller 106, 108.

In some embodiments the system 100 may comprise a singular user interface 120, and in some other embodiments the system 100 may comprise a plurality of user interfaces 120, with each user interface 102 including an input device or portion 122, a display device or portion 124 or both. The input device or portion 122 and the display device or portion 124 of the at least one user interface 102 may thereby be portions or aspects of a common user interface 120, or the input device or portion 122 and the display device or portion 124 may be portions or aspects of separate and distinct interfaces 120.

In some embodiments, the at least one user interface 102 may comprise physical buttons, switches, keypads, icons or other electromechanical and/or digital devices or components that allow a user to manually (physically) engage the at least one user interface 102 to input at least one setting, data, command, prompt, signal or the like into the system 100, such as to the at least one controller 118. In some embodiments, the at least one user interface 102 may comprise at least one graphical user interface (GUI), which may provide both the input device or portion 122 and the display portion 124 for example. However, the at least one interface 120 may comprise LEDs, incandescent lights, an electronic (e.g., digital or analog) screen, display, speakers, vibrators, or other devices that only provide or comprise the display portion 124 of the at least one user interface 102. It is noted that the display portion 124 of the at least one user interface 102 may indicate to the user visually (e.g., vial illumination), audibly (e.g., via an audible sound), tactically (e.g., via a vibration) or a combination thereof.

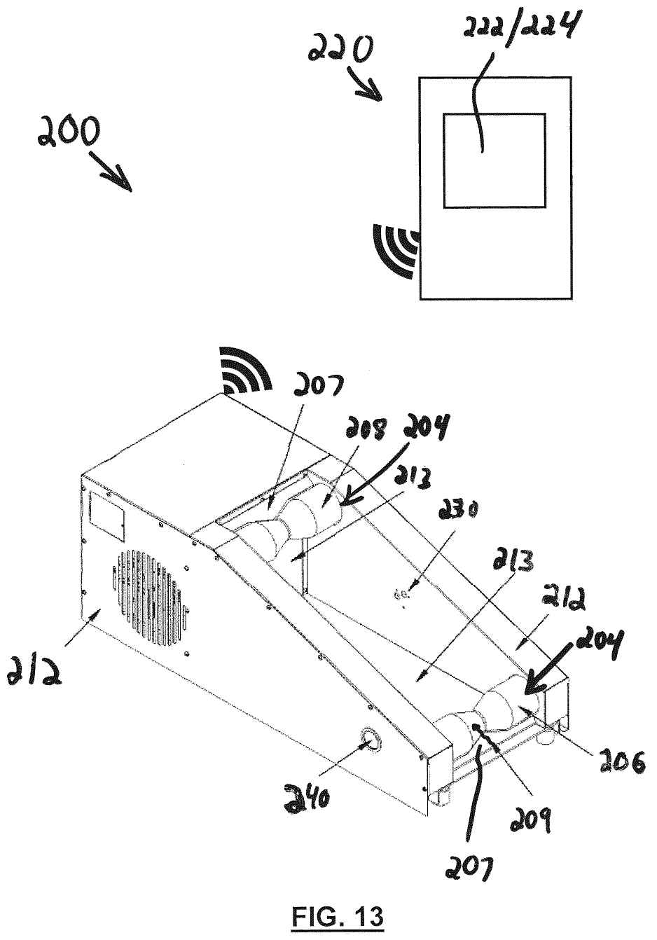

In some embodiments of the system 100, the at least one controller 118 (e.g., a high-level controller) may receive, read or accept at least one user input that is input via at least one input portion 122 of the at least one interface 120. The at least one user input may be at least one operational parameter of the device/system, such as at least one operational parameter of the bedding-in process (e.g., a selection of a particular bedding-in process). For example, in some such embodiments, the at least one controller 118 may store and execute pre-configured programs (e.g., Program A, B, and C) corresponding to differing bedding-in processes or method, each bedding-in process defined by particular cycles of specific/differing braking and cooling operations, and the user input that is input by the user via the at least one input portion 122 of the at least one interface 120 may be a selection of one of the pre-configured stored bedding-in processes. As another example, the at least one input portion 122 of the at least one interface 120 may be configured to input (via user interaction) particulars of a particular bedding-in process, or at least some parameters of a particular bedding-in process. In some other embodiments, as discussed below with respect to FIGS. 13-15, the at least one input portion 122 of the at least one interface 120 may be configured to input, via the user, at least one parameters of the disc brake system 10 of a wheel 14, and the at least one interface 120 and/or the at least one controller 118 may determine the bedding in parameters (e.g., number of cycles, braking timeframes, cooling timeframes, braking levels, etc.) based on the at least one parameters of the disc brake system 10. In some embodiments, the at least one input portion 122 of the at least one interface 120 may be configured to input, via user interaction, the direction of rotation of the roller assembly 104 (via the motor 116), such as an instruction or signal to rotate the roller assembly 104 in a direction or rotation that is suited for a front wheel or suited for a second wheel.

As shown in FIGS. 3-6 and 9, the at least one display portion 124 is configured to provides one or more indications to a user, such as statuses (e.g., real-time statuses), parameters and/or instructions to the user to facilitate a particular bedding-in process or method performed by the bedding-in system 100 and the user acting in concert. As discussed herein, the bedding-in processes performed via the system 100 comprise a plurality of cycles of a braking operation (physically performed by the user activating the brake disc 10 of the wheel 14) of a disc brake system 10 of a cycle wheel 14 and a subsequent cooling operation of the disc brake system 10 (physically performed by the user deactivating the brake disc 10 of the wheel 14) while the wheel 14 is rotated via the roller assembly 104 and at least some of the real-time operational statuses are indicated by the display portion 124 of the at least one interface 120 to guide the user through the process such that an enhanced bedding-in process/result of the disc brake system 10 is achieved.

As also noted above, the braking operations comprise the disc brake system 10 being activated by the user within a defined braking level for a braking timeframe, and the cooling operations comprising the disc brake system 10 not being activated by the user for a cooling timeframe. Accordingly, the display portion 124 of the at least one interface 120 may indicate to a user (visually, audibly and/or tactically) real-time parameters or statuses of a bedding-in process and the particular braking operations and cooling operations instruct the user to operate the disc brake 10 in accordance with the braking and cooling operations. For example, as shown in FIGS. 3-6 and 9 the display portion 124 of the at least one interface 120 may be configured to indicate what particular bedding-in process was selected or input by the user (and being executed by the system), and/or the status (e.g., completion percentage or stage). As also shown, in some embodiments, the display portion 124 of the at least one interface 120 may be configured to indicate the direction of rotation of the roller assembly 104 (such as an indication of whether the direction of rotation of the roller assembly 104 is configured for a front wheel 14 of a cycle or a rear wheel 14 of a cycle.

As also shown in FIGS. 3-6 and 9, in some embodiments, the display portion 124 of the at least one interface 120 may be configured to indicate, during each braking operation according to the selected/input bedding-in process, an indication to the user to perform each braking operation, an indication to the user of a real-time brake level compared to a defined (pre-defined) braking level during each braking operation, and an indication to the user of a real-time status of an amount of time remaining in each braking timeframe. Still further, as also shown in FIGS. 3-6 and 9, in some embodiments, the display portion 124 of the at least one interface 120 may be configured to indicate, during each cooling operation according to the selected/input bedding-in process, an indication to the user to perform each cooling operation, and an indication to the user of a real-time status of an amount of time remaining in each cooling timeframe.

Turning to the at least one controller 118, the bedding-in system 10 may include one or more controller that controls, at least partially, the operation of the at least the motor 116 and of the at least one user interface 120. The at least one controller 118 may also control other components or features of the system 100. In some embodiments, the at least one controller 120 (e.g., a low-level controller) may be configured for operational control and sensor integration of the system 100. The at least one controller 118 may receive or read inputs, signals and/or data from components of the system 100, such as the input portion 122 of the at least one user interface 120 (as discussed above), the motor 116, and sensors and/or switches (or other input devices) of the system 100, such as to determine or obtain additional operational parameters of the system 100. For example, in some embodiments, the at least one controller 118 (e.g., a low-level controller) may control the motor 116 and the display portion 124 of at least one user interface 120, and receive inputs or signals from one or more electrical sensors and/or switches of the system 100. In some exemplary embodiments, the at least one controller 118 (e.g., a low-level controller) may be configured to control the motor 116, such as via starter, to control the start/stop of the motor 116, acceleration of the motor 116, and motor direction, for example. In some such embodiments, one controller 118 of the system 100 may receive commands from another controller 188 of the system 100, and execute such commands, regarding specified braking and cooling operations (e.g., timeframes thereof, number of cycles, etc.) of a particular bedding-in process/method selected or input by a user.

In some embodiments, the at least one controller 118 may comprise a plurality of controllers, such as but not limited to at least one high-level controller and at least one low-level controller, as shown in FIG. 5. The plurality of controllers 118 may be electrically coupled (e.g., via wiring) and/or wirelessly coupled and communicate with each other. For example, in one exemplary embodiment, the system 100 includes a first controller 118 (e.g., a high-level controller) that communicates with a second controller 118 (e.g., a high-level controller) for data exchange and coordination of the operations thereof, such as via a robust RS485 data interface. In the exemplary illustrative embodiment as shown in FIG. 5, the system 100 includes a first controller 118 (e.g., a high-level controller) as part of or beneath the at least one user interface 120 mounted at the top portion of the base 102, and a second controller 118 (e.g., a low-level controller) coupled within the base 102 proximate to the motor 116, for example.

The at least one controller 118 may comprise at least one device or chip that includes memory with stored executable instructions and a processor that executes the executable instructions, such as comprising a microprocessor. The at least one controller 118 is configured to manage the operation of other components by receiving input, comparing it to a desired setting (setpoint), and generating an output signal to make adjustments, acting as the “brain” of the bedding-in system 100. The at least one controller 118 manages the motor 116, the at least one user interface 120 and sensors, switches, input/output adapters, display signals, data access and other operations of the system 100. For example, as discussed further below, the at least one controller 118 is configured for input processing such that it reads signals or data from sensors and other devices/components and input from the input portion 122 of the at least one user interface 120 (e.g., button press, sensor activation, sensor detection, temperature, etc.). The at least one controller 118 is also configured for data comparison such that it compares sensed and/or input values to setpoint or threshold values, for example. The at least one controller 118 is also configured to determine and send signals to devices, such as the display portion 124 of the at least one user interface 120.

In some embodiments, the at least one controller 118 (e.g., a high-level controller) may comprise at least one input/output connector or adapter (not shown) that facilitates the input and/or output of data with the at least one controller 118, such as for software and/or firmware installation and/or updates, diagnostics, maintenance and software enhancements. The at least one input/output connector or adapter may comprise a USB interface, for example. As another example, the at least one input/output connector or adapter may comprise a WiFi adapter, Bluetooth adapter or other wireless connection mechanism remote operation and monitoring of the system 100. For example, a WiFi adapter can connect the device/at least one controller to the internet/data cloud for (e.g., via a computer, smartphone, tablet or like digital or analog electronic device that is remote or physically separated from the at least one controller 118). Similarly, Bluetooth capability can allow wireless communication or operation of the at least one controller 118 via a device. It is noted that the input/output connector or adapter may allow the at least one interface 120, or at least the input portion 122 and/or at least one display portion 124 thereof, to be remote or physically separated from the base 102 and/or at least one controller 120. For example, a smartphone or tablet or other electronic device may be utilized as, or form part of, the at least one user interface 120 (or at least one of the input portion 122 and/or the display portion 124 thereof), which communicates with the at least one controller 118 mounted to/at the base 102 via the input/output connector.

As discussed above, the at least one controller 118 monitors a plurality of real-time operational statuses of the system 100, and controls the electric motor 116 and the at least one user interface 120, based on the at least one operational parameter input by the input interface portion 122 (the selection or input of a particular bedding-in process) and the real-time operational statuses, to execute a bedding-in process that beds-in the disc brake 10 of the wheel 14 of the wheeled cycle. Each bedding-in process comprises a plurality of cycles of a braking operation of the disc brake system 10 of the wheel 14, and cooling operation immediately following each braking operation, while the wheel 14 is rotated via the roller assembly 104 (the front and rear rollers 106, 108) and the at least one controller 118 controls the user interface 120 such that at least some of the real-time operational statuses are indicated by the display portion 124. As also discussed above, each braking operation of a bedding-in process comprises the at least one controller 118 activating the motor 116 such that the roller assembly 104 rotates the wheel 14, and controlling the user interface 120 according to the selected/input bedding-in process such that the display portion 124 provides indications to the user to activate the disc brake 10 of the wheel 14, control/operate the activated disc brake 10 within a defined braking level, and the status of a braking timeframe of the braking operation for which the user maintains the activation of the disc brake 10 within the defined braking level. Similarly, each cooling operation of a bedding-in process comprises the at least one controller 118 activating the motor 116 such that the roller assembly 104 rotates the wheel 14, and controlling the user interface 120 according to the selected/input bedding-in process such that the display portion 124 provides indications to the user to deactivate the disc brake 10 of the wheel 14, and the status of a cooling timeframe of the cooling operation for which the user maintains the deactivation of the disc brake 10.

The at least one controller 118 thereby executes a bedding-in process that is selected or input by a user. As noted herein, a plurality of differing bedding-in processes may be stored within the at least one controller 118 (e.g., within memory of the at least controller 118 or the system 100), or may be input into or accessed by the at least one controller 118 (e.g., communicated to the at least one controller 118). The at least one controller 118 thereby executes each part of the program corresponding to a respective selected bedding-in process which comprises monitoring operational parameters of the system 100 and operating the motor 116 (and thereby the roller assembly 104) and the at least one user interface 120 (specifically, the display portion 124) based on the respective selected bedding-in process and the real-time statuses of the monitored operational parameters.

For example, in some embodiments, the at least one controller 118 may store and execute pre-configured programs (e.g., Program A, B, and C) corresponding to differing bedding-in processes, each bedding-in process defined by particular cycles of specific/differing braking and cooling operations, and the at least one operational parameter that is input by the user via the at least one input portion 122 of the at least one interface 120 may be a selection of one of the pre-configured stored bedding-in processes. In some other examples, the least one operational parameter input by the user via the at least one user interface 120 which the at least one controller 118 bases the operation of the system 100 to perform a bedding-in process may comprise an input number of braking and cooling cycles, one or more input braking levels for one or more braking operations, and one or more input braking timeframes for one or more braking operations. As another example, the least one operational parameter input by the user via the at least one user interface 120 which the at least one controller 118 bases the operation of the system 100 to perform the bedding-in processes may be a selection of the direction of rotation of the motor, and thereby the direction of rotation of the roller assembly 104, to suit a front wheel 14 or a rear wheel 14 of a cycle.

For example, in some embodiments, the at least one controller 118 may comprise at least first, second and third differing bedding-in processes/methods saved or stored therein. For example, the first bedding-in process/method may comprise six braking and cooling cycles with the braking timeframes each being a first timeframe (e.g., 15 seconds) and the cooling timeframes each being a second timeframe (e.g., 10 seconds), the second bedding-in process/method may comprise six braking and cooling cycles with the first three braking timeframes each being a first timeframe (e.g., 15 seconds) and the subsequent three braking timeframes each being a second timeframe (e.g., 20 seconds), and the cooling timeframes each being a third timeframe (e.g., 10 seconds), and the third bedding-in process/method may comprise six braking and cooling cycles with the first two braking timeframes each being a first timeframe (e.g., 15 seconds) and the subsequent four braking timeframes each being a second timeframe (e.g., 20 seconds), and the cooling timeframes each being a third timeframe (e.g., 10 seconds).

The at least one controller 118 may be configured to monitor various differing operational statuses of the system 100, and control the electric motor 116 and the at least one user interface 120 based on at least some of the real-time operational statuses (and the at least one operational parameter input by the user interface 120, such as the selection or input of a particular bedding-in process, as described above). The real-time statuses of the system 100 and bedding-in processes that are monitored or managed by the at least one controller 118 (and potentially indicated to a user by the display portion 124) may comprise any current/real-time setting, state, status, instruction and/or other parameter relating to the condition of an aspect of the bedding-in process and/or the system 100 during a bedding-in process.

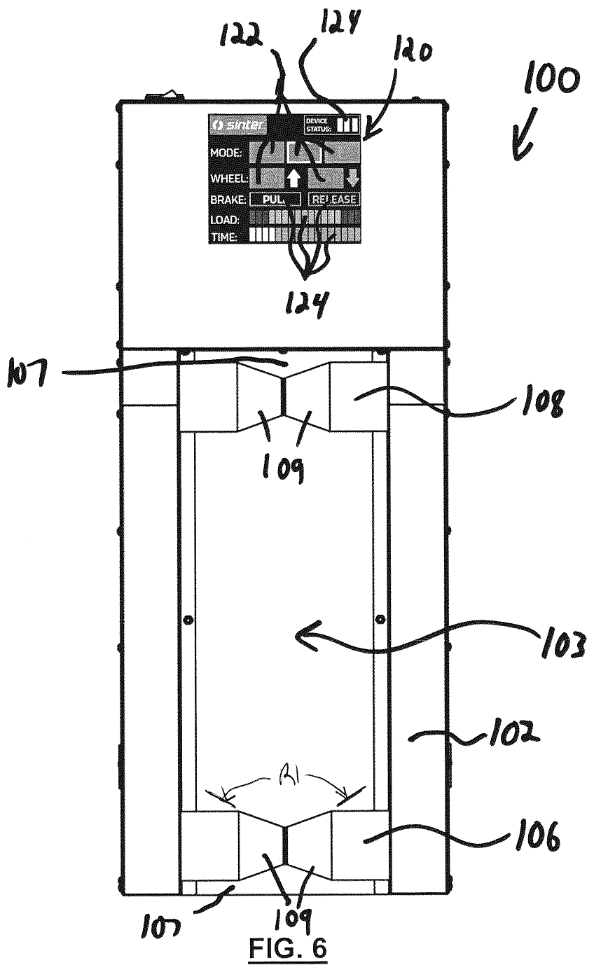

In some embodiments, the real-time statuses of the system 100 and bedding-in processes that are monitored or managed, and which may be indicated via the display portion 124, by the at least one controller 118 may comprise a device progress or status of a current bedding-in process being performed by the system 100 (e.g., the number of completed braking and cooling cycles as compared to the total number of cycles of the current bedding-in process being performed, or the current stage or step of the of the current bedding-in process being performed relative to the total number of stages or steps of the of the bedding-in process), as shown in FIG. 6. As also shown in FIG. 6, in some embodiments, the real-time statuses of the system 100 and bedding-in processes that are monitored or managed, and may be indicated via the display portion 124, by the at least one controller 118 may comprise which particular bedding-in process was selected or input by the user.

In some embodiments, as shown in FIGS. 3-5, 9, 10 and 12, the system 100 may be configured such the at least one controller 118 is configured to receive, detect and/or monitor the real-time operational statuses via one or more sensors, detectors, switches or other detection or input devices (to determine or obtain additional operational statuses of the system 100). For example, in some embodiments, the at least one controller 118 (e.g., a high-level and/or low-level controller) may receive or monitor data, signals, input and/or statuses one or more sensors, switches or other input devices as current or real-time operational statuses or indications thereof.

For example, in some embodiments, the bedding-in system 100 comprises a wheel insertion sensor 130 configured to detect a real-time operational status of the presence (or absence) of the wheel 14 within the opening 103 and engaged with the rear and front rollers 106, 108. The at least one controller 118 may be configured to execute the bedding-in process only when the presence of the wheel 14 is detected by the wheel insertion sensor 130. For example, the at least one controller 118 may be configured to begin a bedding-in process when a user inputs a selection of a particular bedding-in process via the user interface 120 and the wheel insertion sensor 130 detects presence of a wheel 14 positioned within the opening 103 and/or engaged with the rollers 106, 108. The at least one controller 118 may also be configured to stop or pause a bedding-in process when the wheel insertion sensor 130 detects the absence (e.g., no longer detects the presence) of a wheel 14 positioned within the opening 103 and/or engaged with the rollers 106, 108. The presence/absence of the wheel 14 positioned within the opening 103 and/or engaged with the rollers 106, 108 may thereby comprise one of the real-time operational statuses monitored and considered by the at least one controller 120 (and which may or may not be indicated to a user via the display portion 124 of the at least one user interface 120).

In some embodiments, the wheel sensor 130 may be a touch-less sensor. For example, the wheel sensor 130, in some embodiments, may be an light/infrared sensor that comprises an light-emitting module positioned on one side of the opening 103 of the base 102 that emits a light beam (infrared (IR) light), and a light-detecting module positioned on another (e.g., opposing) side of the opening 103 of the base 102 that receives the emitted light beam (e.g., IR light). The light sensor (e.g., IR sensor) may be configured such that when the light beam is obstructed by the insertion of a wheel 14 in the opening 103 and positioned on the rollers 106, 108 of the roller assembly 104, the detecting module informs the at least one controller (e.g., a low level controller) accordingly (and the at least one controller 118 may enable appropriate motor 116 and system responses based thereon, for example). In some embodiments, the wheel sensor 130 may be another type of touch-less sensor (e.g., a motion sensor), or may be a contact sensor, or other type of detection sensor or switch operable to provide an input or signal related to the presence or absence of a wheel 14 being positioned within the opening 103 and/or engaged with the rollers 106, 108.

An another example, as shown in FIGS. 3-5, 9, 10 and 12, the bedding-in system 100 may comprises a rotation direction control switch or sensor 140 operatively coupled with the at least one controller 118 that sets the direction of rotation of the electric motor 116, and thereby the roller assembly 104, based on the state or operation of the rotation direction switch or sensor 140. In such embodiments, the at least one controller 118 may be configured to detect a real-time operational status of the rotation direction switch or sensor 140, or receive a signal therefrom based on user operation of the rotation direction switch or sensor 140, and set, instruct or operate the direction of rotation of the electric motor 116, and thereby the roller assembly 104, based thereon. The state or operation of the rotation direction sensor/switch 140 may thereby comprise one of the real-time operational statuses monitored and considered by the at least one controller 120 (and which may or may not be indicated to a user via the display portion 124 of the at least one user interface 120).

In some embodiments, the rotation direction sensor/switch 140 may be coupled or mounted on the base 102 such that the rotation direction sensor/switch 140 can be operated or utilized by a user. For example, in some embodiments, the rotation direction sensor/switch 140 may be mounted an exterior side portion of the base 102 and be configured to be manually operated by a user while utilizing the system 100 (such as while manually supporting or position a cycle such that a front or rear wheel 14 thereof is engaged with the rollers 106, 108, as shown in FIGS. 9-12. In some such embodiments, the rotation direction sensor/switch 140 may be configured to be operated by a foot or leg of a user.

The rotation direction sensor/switch 140 may be any electrical, electro-mechanical or mechanical switch operative to provide a signal or state to the controller 118. For example, in some embodiments, the rotation direction sensor/switch 140 may be a touch-less switch or sensor. For example, the rotation direction sensor/switch 140, in some embodiments, may be a touchless sensor or switch, such as a motion sensor or switch that detects motion of an object that translates past or in front of the sensor and produces a signal in response thereto. In some embodiments, the wheel sensor 130 may be another type of touch-less sensor (e.g., a motion sensor), the rotation direction sensor/switch 140 may be another type of touch-less sensor or switch, or may be a contact or physical sensor or switch, or other type of sensor or switch operable to provide an input or signal that the at least one controller 118 monitors or considers as a real-time operational status to control the direction of rotation of the motor 116, and thereby the roller assembly 104, during a bedding-in process.

It is noted that the system 100 may be configured to rotate that motor 116, and thereby rollers 106, 108, during a bedding-in process in a direction of rotation corresponding to the direction of rotation of the wheel 14 during forward motion of the cycle during use. Accordingly, the rotation direction sensor/switch 140 may be configured to be utilized by the user to switch the direction of rotation of the motor 116, and thereby rollers 106, 108, to accommodate or configure the system 100 for the bedding-in of a front wheel 14 with the cycle/front wheel 14 engaged with the rollers 106, 108 in a forward-facing direction of the wheel and cycle with respect to the base 102 or a rear wheel 14 with the cycle/rear wheel 14 engaged with the rollers 106, 108 in a rearwardly-facing direction of the wheel and cycle with respect to the base 102. In this way, the rotation direction sensor/switch 140 can be utilized by a user to switch the direction of rotation of the motor 116, and thereby rollers 106, 108, so that a respective front wheel 14 or rear wheel 14 is rotated in a direction of rotation during a bedding-in process by the system 100 corresponding to the direction of rotation of the respective front or rear wheel 14 during forward motion of the cycle during use.

As shown in FIG. 6, in some embodiments, the at least one controller 118 is configured to detect and/or determine the real-time operational status of a real-time brake level of a disc brake system 10 of a wheel 14 during a bedding-in process, such as during each breaking operation. The real-time brake level may thereby comprise one of the real-time operational statuses monitored and considered by the at least one controller 120 (and which may or may not be indicated to a user via the display portion 124 of the at least one user interface 120).

For example, in some embodiments of the system 100, during a calibration portion of a bedding-in process, the at least one controller 118 may be configured to determine or sense a setpoint or baseline speed of rotation of the roller assembly 10 with a wheel 14 engaged with the front and rear rollers 106, 108 (and thereby the speed of rotation of the wheel 14) prior to any braking operation of the disc brake system 10 of the wheel. In some embodiments, the at least one controller 118 may be configured to determine or set the baseline speed of rotation at the outset of a particular bedding-in process during a calibration process (wherein the at least one controller 118 rotates the roller assembly 104 with the wheel 14 engaged with the roller assembly 104 and the disc brake 10 of the wheel 14 not utilized/engaged by the user). The at least one controller 118 may further be configured determine or sense a current/real-time speed of rotation of the roller assembly 104 (and thereby the speed of rotation of the wheel 14) during a braking operation of the disc brake system 10 of the wheel 14, and to compare the real-time speed of rotation of the roller assembly 104 (or the speed of rotation of the wheel 14) during the braking operation to the baseline speed of rotation to determine a real-time brake level of the disc brake system 10 of the wheel 10 during each braking operation (as one of the real-time operational statuses monitored and indicated by the at least one controller 120).

In some embodiments, the at least one controller 118 may detect, monitor or measure the speed of rotation of a part/component of the roller assembly 104 (the belt drive 112, for example) via a sensor to determine the real-time speed of rotation of the roller assembly 104 (and thereby the speed of rotation of the wheel 14) to determine the baseline speed of rotation and the real-time brake levels (as real-time operational statuses monitored and considered by the at least one controller 120). For example, in some embodiments, the system 100 may detect, monitor, measure or otherwise determine the speed of rotation of the roller assembly 104 (and thereby a wheel engaged therewith) via a magnetic-field sensor that detects the presence of a magnetic marker or member that is coupled to a portion of one of the pulleys 16, 106′, 108′ or the belt drive 112 of the roller assembly 104 (or the wheel 14) to determine the time of a round-trip of the marker or member, and thereby the speed of rotation of the roller assembly 104. The at least one controller 118 is configured to receive signals from the sensor to determine the baseline speed of rotation and the real-time brake level. However, in some embodiments, the at least one controller 118 may detect, monitor, measure or otherwise determine the speed of rotation (or other movement) of the roller assembly 104 and/or a wheel 14 via a differing type or configuration of a sensor or switch operatively coupled with the roller assembly 114. In some other embodiments, the at least one controller 118 may detect, monitor, measure or otherwise determine the speed of rotation (or other movement) of the roller assembly 104 and/or a wheel 14 via detecting, monitoring or measuring a component or part of the system 10 that is not a component or part of the roller assembly 114. For example, the device/system may detect, monitor, measure or otherwise determine the speed of rotation of the motor 116, such as directly detecting the motion of a component of the motor or indirectly by determining the voltage or current draw of the motor 116. In some other embodiments, the movement or speed of rotation of a wheel 14 engaged with the rollers 106, 108 may be detected, monitored, measured or otherwise determined by the at least one controller 118 via at least one sensor.

In some embodiments, the at least one controller 118 may further be configured to compare a determined or sensed real-time brake level to a defined (e.g., predefined) braking level (i.e., a defined speed reduction amount or level), such as 10%, 15% or 20% reduction of the baseline speed of rotation of the roller assembly 104/wheel 14, and control the display portion 124 of the at least one user interface 120 to provide an indication to the user of the real-time braking level compared to the defined braking level, as a real-time status of the device/system 100. The defined braking level, used to compare a real-time braking level, may be defined according to a particular bedding-in process/method selected or input by a user, or may be specifically set or input by the use (e.g., via the at least one user interface 120). In some embodiments, the at least one controller 118 may indicate the real-time breaking level of a braking operation being greater than or less than the defined breaking level, and an indication of the degree thereof, as shown in FIG. 6. The real-time breaking level indicated by the display portion 124 of the at least one user interface 120 may thereby be utilized by a user to adjust the operation of the disc brake system 10 of the wheel 14 during a breaking operation to control the application of the brake pads 26 on the rotor (to ensure a consistent high-quality transfer layer on the rotor surfaces is achieved). It is noted that the defined braking level/speed reduction amount may be a set braking level throughout all bedding-in processes and/or all braking operations of a particular bedding-in process, or may differ from bedding-in processes or between braking operations of a particular bedding-in process.

In some embodiments, the at least one controller 118 may be configured to monitor the roller assembly 104, the motor 116 and/or the wheel 14 engaged with the roller assembly 104 to determine a real-time slippage of the wheel 14 with the roller assembly 104. Any real-time slippage may thereby comprise one of the real-time operational statuses monitored and considered by the at least one controller 120 (and which may or may not be indicated to a user via the display portion 124 of the at least one user interface 120). The at least one controller 118 may be configured to pause or stop a bedding-in process/method being performed if real-time wheel slippage (or wheel removal/disengagement) is detected. In some such embodiments, the at least one controller 118 may be configured store the status of the bedding-in process/method such that a paused or stopped bedding-in process/method can be restarted from the point of interruption after the wheel slippage has stopped (or the wheel 14 is re-inserted or engaged).

In some embodiments of the system, the braking timeframes of the braking operations and/or the cooling timeframes of the cooling operations are fixed timeframes. For example, the bedding-in processes that are selected or input via the use (e.g., via the at least one operational parameter input by the at least one user interface) may include fixed predefined timeframes. The at least one controller 118 may keep track of the real-time statuses of the braking operations and/or the cooling timeframes and operate the system 100 accordingly.

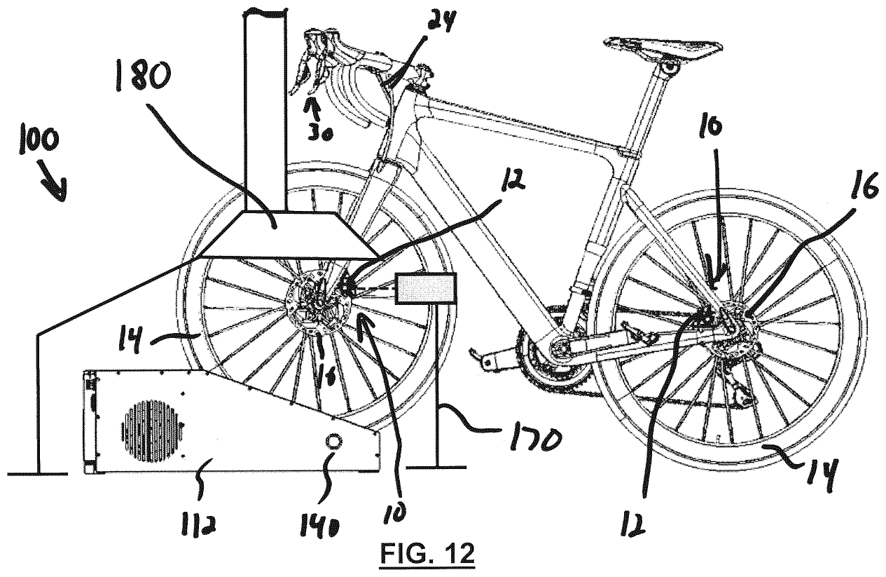

In some other embodiments, as shown in FIG. 12, the bedding-in system 100 may further comprise a temperature sensor 170 configured to sense the temperature of the rotor 16 and/or a brake pad of the brake pads 26 of the disc brake 10 of the cycle. In such embodiments, the at least one controller 118 determines the braking timeframes of the braking operations and/or the cooling timeframes of the cooling operations based on the sensed temperatures of the rotor 16 and/or brake pads 26 during respective braking and cooling operations. For example, the at least one controller 118 may be configured to stop a respective braking operation and/or cooling operation when a particular setpoint temperature is reached. As another example, in some such embodiments, the at least one controller 118 may determine the braking timeframes of the braking operations and/or the cooling timeframes of the cooling operations based on the sensed temperatures and a defined total amount of heat flux applied/generated in the rotor 16 and/or brake pads 26. In this way, the braking timeframes and/or the cooling timeframes may be variable timeframes that depend on the temperature of, or heat generated in, the rotor 16 and/or a brake pads 26. In some embodiments, the temperature sensor 170 may be a touchless temperature sensor (e.g., an infrared temperature sensors) as shown in FIG. 12. However, other types of temperature sensor configurations may equally be employed.

As also shown in FIG. 12, in some embodiments the system 100 may include an exhaust system 180 that is configured to remove or exhaust fumes and airborne particles that are generated during a bedding-in process from an area extending about the system 100 and wheel 14 (or the cycle). The exhaust system 180 may be operated (e.g., turned on and off) automatically by the at least one controller 118 during a bedding-in process.

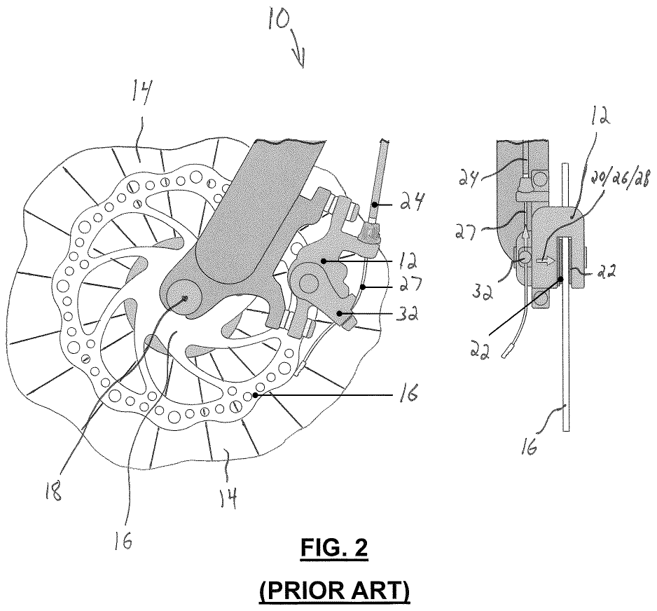

FIGS. 13-15 illustrate another exemplary bedding-in system 200 according to the present disclosure. The bedding-in system 200 of FIGS. 13-15 is substantially similar to the bedding-in system 100 of FIGS. 2-12 described above, and therefore like reference numerals preceded with “2” as opposed to “1” are used to indicate like components, aspects, functions, processes or functions, and the description above directed thereto equally applies, and is not repeated for brevity and clarity purposes. As shown in FIGS. 13-15, bedding-in system 200 differs from bedding-in system 100 in the configuration of the at least one user interface 220.

As shown in FIG. 13, the system 100 includes at least one remote user interface 220 that is physically separated from the base 202 and communicates wirelessly with the at least one controller 118. For example, the at least one remote user interface 220 may comprise a smartphone, tablet, computer or other electronic device that wirelessly communicates (e.g., via Bluetooth, WiFi, or the like) with the at least one controller 218 at/on the base 202 of the system 100.

In some embodiments, as shown in FIGS. 13-15, the at least one remote user interface 220 may comprise a graphical user interface (GUI) (e.g., a screen, such as touchscreen) that forms, or is configured as, the at least input portion 122 and the at least one display portion 124 of the user interface 220. In such embodiments, the one remote user interface 220 displays the indications to the user, and allows the user to interact with the remote user interface 220 to provide the user inputs.

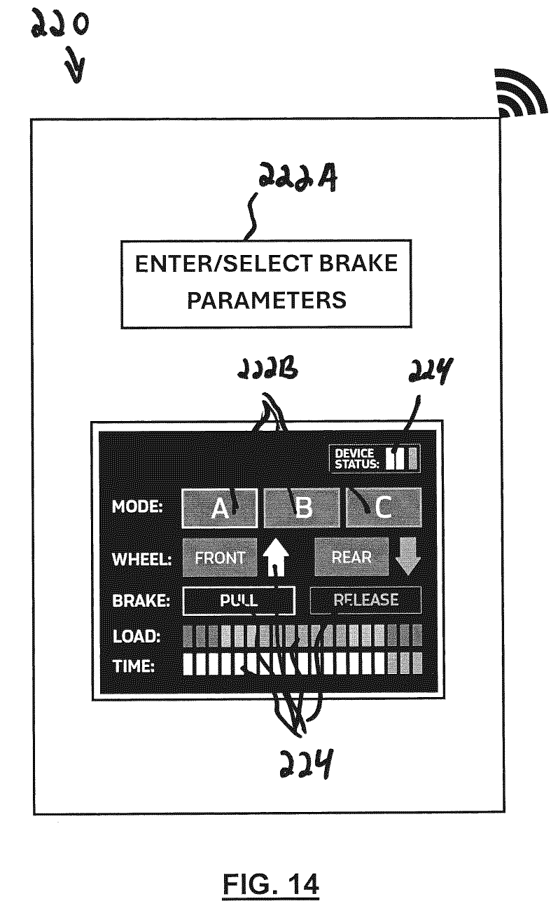

As shown in FIG. 14, in some embodiments, the at least one remote user interface 220 may include a second display and input portion 222B that provides indication of particular pre-configured or defined bedding-in processes with particular cycles of braking and cooling operations, as discussed above. The at least one remote user interface 220 may be configured such that a user can utilize the at least one remote user interface 220 to select one of the pre-configured or defined bedding-in processes, and the at least one remote user interface 220 and the at least one controller 218 can be configured such that the at least one remote user interface 220 communicates (e.g., wirelessly) the selection of the pre-configured or defined bedding-in process to the at least one controller 218 (which initiates and runs the selected bedding-in process).

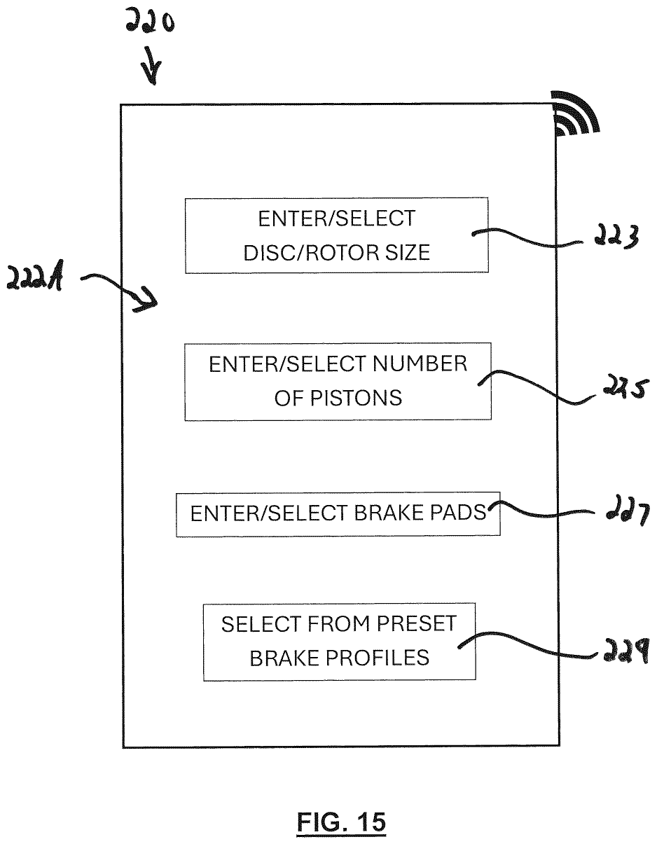

With reference to FIGS. 14 and 15, in some embodiments, the at least one remote user interface 220 may include a first display and input portion 222A that provides a user the option of entering or inputting at least one disc brake parameter of the disc brake system 10 of a wheel 14 or cycle into the at least one remote user interface 220. For example, as shown in FIG. 15, the at least one remote user interface 220 may may provide for a rotor size parameter input 223, a piston number or arrangement parameter input 225 (e.g., number of pistons of the caliper), and/or a brake pad parameter input 227 (e.g., brake pad composition, size, brand, model, quantity, etc.). In some embodiments of the at least one remote user interface 220, the first display and input portion 222A may provide for the selection of one of a plurality of differing preset brake profiles that correspond to the general nature of the disc brakes 10 of a cycle, such that the general configuration or type of disc brakes, the type of cycle 10, the projected use of the cycle, or differing braking performance levels or styles. In some such embodiments, at least one of the at least one remote user interface 220 and the at least one controller 218 of the system 200 is configured to determine or select a corresponding bedding-in process with particular braking and cooling operations suited for the input at least one disc brake parameter, and the at least one controller 218 is configured to execute the determined or selected corresponding bedding-in process.

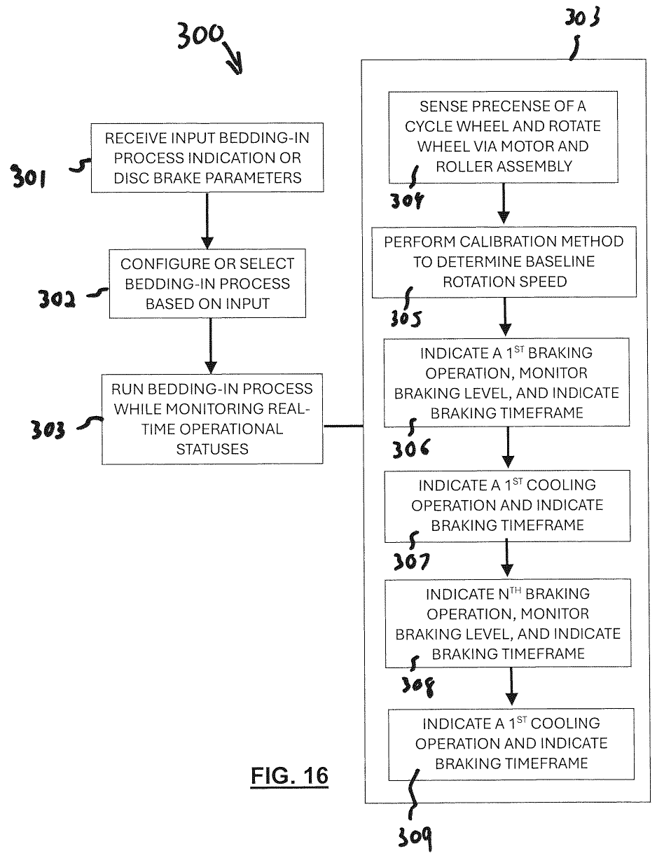

An exemplary bedding-in method 300 performed, provided or facilitated by the bedding-in systems of the presented disclosure (in concert with a use) is illustrated in a flowchart in FIG. 16. As shown in FIG. 16, at 301, the bedding-in method 300 may comprise the user utilizing the input interface portion of the at least one user interface to input an indication of a particular selected bedding-in process or at least one operational parameter such that the system (e.g., the at least one controller thereof) receives an input bedding-in process indication or disc brake parameters. Based on the input bedding-in process indication or disc brake parameter(s), at 302, the system (e.g., the at least one controller thereof) may select a corresponding bedding-in process stored in the at least one controller, or configure or determine a corresponding bedding-in process based on the disc brake parameter(s) via the at least one controller.

With continued reference to FIG. 16, at 303, the system may execute, operate or run the selected or determined corresponding bedding-in process. As described herein and shown in FIG. 16, executing the selected or determined corresponding bedding-in process may comprise, at 304, initiating the bedding-in process may comprise sensing/determining that a wheel is inserted into the opening of the base of the system, and engaged with the front and rear rollers of the roller assembly. Initiating the bedding-in process may comprise activating the motor assembly in a selected direction of rotation to rotate the wheel assembly at particular rotational speed, and thereby rotate the wheel engaged therewith. At 305, with the wheel being initially orated via the roller assembly, the method may then comprise performing the calibration process of determining the baseline rotational speed of the roller assembly or wheel (or other component) for the determination of a braking level during a braking operation.

In some embodiments, after the baseline rotational speed is determined, the method may comprise, at 306, performing a first braking operation. As discussed above, performing a first braking operation may comprise indicating to the user via the display portion of the user interface that a braking operation is to be performed, which instructs the user to activate the disc brake of the wheel engaged with the rollers. Performing the first braking operation may also comprise initiating and monitoring a first braking timeframe for the first braking operation, and indicating the real-time status of the first braking timeframe on the display portion. Performing the first braking operation may further comprise determining a real-time braking level applied to the wheel, and indicating the braking level on the display portion. As disclosed herein, indicating the real-time braking level of the first braking operation on the display portion may comprise indicating the braking level in relation/comparison to a preset braking level to provide guidance to the user in activating the brake system (i.e., to apply more or less braking, and to what degree).

As shown in FIG. 16, at the conclusion of the first braking timeframe, at 307, the method 300 may comprise performing a first cooling operation. As discussed above, performing a first cooling operation may comprise indicating to the user via the display portion of the user interface that a cooling operation is to be performed, which instructs the user to deactivate the disc brake of the wheel. Performing the first cooling operation may also comprise initiating and monitoring a first cooling timeframe for the first cooling operation, and indicating the real-time status of the first cooling timeframe on the display portion.

Lastly, with continued reference to FIG. 16, at the conclusion of the first cooling timeframe, at 308, the bedding-in method 300 may comprise performing one or more cycles of braking and cooling operations according to the selected or determined corresponding bedding-in process. For example, the method may comprise performing N^{th} cycles of N^{th} braking operations followed by respective N^{th} cooling operations, to bed-in the disc brake with a consistent high-quality transfer layer on the rotor surfaces which provides superior braking performance.

It is to be understood that the above description is intended to be illustrative, and not restrictive. For example, the above-described examples (and/or aspects thereof) may be used in combination with each other. For example, one feature, component, sub-assembly, configuration, component shape, arrangement or the like, of one or more aspects of one cycle disc brake bedding-in system or method embodiment may be equally employed or employed in a functional fashion to a different cycle disc brake bedding-in system or method embodiment. Accordingly, the features of each of the disclosed cycle disc brake bedding-in system or method embodiments are hereby disclosed with respect to each other disclosed cycle disc brake bedding-in system or method embodiments, and the features thereof may be combined, swapped, duplicated, etc.

In addition, many modifications may be made to adapt a particular situation or material to the teachings of the various examples without departing from their scope. While dimensions and types of materials may be described herein, they are intended to define parameters of some of the various examples, and they are by no means limiting to all examples and are merely exemplary. Many other examples will be apparent to those of skill in the art upon reviewing the above description. The scope of the various examples should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as referee labels, and are not intended to impose numerical, structural or other requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S.C. § 112, sixth paragraph, unless and until such claim limitations expressly use the phrase “means for” followed by a statement of function cavity of further structure.

It is to be understood that not necessarily all such objects or advantages described above may be achieved in accordance with any particular example. Thus, for example, those skilled in the art will recognize that the devices, systems and methods described herein may be embodied or carried out in a manner that achieves or optimizes one advantage or group of advantages as taught herein without necessarily achieving other objects or advantages as may be taught or suggested herein.

While the disclosure has been described in detail in connection with only a limited number of examples, it should be readily understood that the disclosure is not limited to such disclosed examples. Rather, this disclosure can be modified to incorporate any number of variations, alterations, substitutions or equivalent arrangements not heretofore described, but which are commensurate with the spirit and scope of the disclosure. Additionally, while various examples have been described, it is to be understood that aspects of the disclosure may include only one example or some of the described examples. Also, while some embodiments are described as having a certain number of elements, it will be understood that the examples can be practiced with less than or greater than the certain number of elements.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

We claim:

1. A system for bedding-in a disc brake of a wheeled cycle that comprises a brake rotor fixed to a wheel of the cycle and a pair of brake pads mounted on a caliper that selectively compress against the brake rotor while the wheel and rotor are rotating during a braking operation of the disc brake, comprising:
a base defining an opening configured to receive the wheel of the wheeled cycle;
a roller assembly comprising a rear roller and a front roller each rotatably coupled with the base and extending across the opening, the rear and front rollers configured to engage the wheel of the cycle;
an electric motor mounted to the base and operatively coupled with the roller assembly configured to rotate at least one of the rear and front rollers of the roller assembly to rotate the wheel and rotor of the cycle;
at least one user interface comprising a display portion and an input interface portion that inputs at least one operational parameter; and
at least one controller that monitors real-time operational statuses of the system, and controls the electric motor and the at least one user interface, based on the at least one operational parameter input by the input interface portion and the real-time operational statuses, to execute a bedding-in process that beds-in the disc brake of the wheel of the wheeled cycle,
wherein the bedding-in process comprises a plurality of cycles of a braking operation and a subsequent cooling operation while the wheel is rotated via the roller assembly and at least some of the real-time operational statuses are indicated by the display portion, the braking operations comprising the disc brake being activated by a user within a defined braking level for a braking timeframe, and the cooling operations comprising the disc brake not being activated by the user for a cooling timeframe,
wherein the real-time operational statuses that are indicated by the display portion during the bedding-in process instruct the user to operate the disc brake in accordance with the braking and cooling operations and comprise:
an indication to the user to perform a first braking operation;
an indication to the user of a real-time brake level compared to the defined braking level during the first braking operation; and
an indication to the user to perform a first cooling operation after the first braking operation;
an indication to the user to perform a second braking operation after the first cooling operation;
an indication to the user of a real-time brake level compared to the defined braking level during the second braking operation; and
an indication to the user to perform a second cooling operation after the first braking operation.

2. The system of claim 1, wherein, during the bedding-in process, the at least one controller determines a baseline speed of rotation of the roller assembly with the wheel engaged with the front and rear rollers prior to the braking operations, and wherein the at least one controller compares the real-time speed of rotation of the roller assembly during a braking operation to the baseline speed of rotation to determine the real-time brake level compared to the defined braking level during a braking operation.

3. The system of claim 2, wherein the at least one controller determines the defined braking level as a defined reduction of the baseline speed of rotation.

4. The system of claim 1, wherein the braking timeframe of the braking operations is a fixed timeframe that is set via the at least one operational parameter input by the input interface portion, wherein the cooling timeframe of the cooling operations is a fixed timeframe that is set via the at least one operational parameter input by the input interface portion.

5. The system of claim 1, further comprising a temperature sensor configured to sense the temperature of the rotor and/or a brake pad of the brake pads of the disc brake of the cycle, and wherein the at least one controller determines the braking timeframe of the braking operations and the cooling timeframe of the cooling operations based on the sensed temperatures of the rotor and/or a brake pad during the respective braking and cooling operations.

6. The system of claim 5, wherein the at least one controller determines the braking timeframe of the braking operations and the cooling timeframe of the cooling operations based on the sensed temperatures and a defined total amount of heat or a maximum temperature.

7. The system of claim 1, wherein the at least one user interface comprises a local user interface that is mounted on the base and operatively coupled with the at least one controller via wiring.

8. The system of claim 1, wherein the at least one user interface comprises a remote user interface that is physically separated from the base and communicates wirelessly with the at least one controller.

9. The system of claim 1, wherein the at least one controller comprises a processor and memory, wherein a plurality of differing bedding-in processes are stored within the memory of the at least one controller, the plurality of differing bedding-in processes comprising at least one of differing numbers of cycles of the braking and cooling operations and differing braking timeframes, and wherein the at least one operational parameter input by the input interface portion of the at least one user interface comprises a user selection of one of the plurality of differing bedding-in processes such that the at least one controller executes the selected one of the plurality of differing bedding-in processes.

10. The system of claim 1, wherein the input interface of the at least one user interface is configured obtain at least one disc brake parameter of the disc brake of the cycle from the user, wherein at least one of the at least one user interface and the at least one controller is configured to determine or select a corresponding bedding-in process with particular braking and cooling operations suited for the disc brake of the cycle based on the obtained at least one disc brake parameter, and wherein the at least one controller is configured to execute the determined or selected corresponding bedding-in process.

11. The system of claim 10, wherein the at least one disc brake parameter of the disc brake of the cycle comprises at least one of a number of pistons of the caliper of the disc brake, a size of the rotor of the disc brake, and an identification of the brake pads of the disc brake.

12. The system of claim 10, wherein the at least one user interface comprises a processor and memory, and is configured to determine or select the corresponding bedding-in process based on the input at least one disc brake parameter, and wherein the input at least one operational parameter comprises an indication of the corresponding bedding-in process.

13. The system of claim 1, wherein the real-time operational statuses that are indicated by the display portion during the bedding-in process further comprise:
during a cooling operation, an indication to the user of a real-time status of an amount of time remaining in the cooling timeframe of the cooling operation; and
during a braking operation, an indication to the user of a real-time status of an amount of time remaining in the braking timeframe of the braking operation.

14. The system of claim 1, further comprising a rotation mode switch operatively coupled with the at least one controller, and wherein the rotation mode switch sets the direction of rotation of the electric motor, and thereby the direction of rotation of at least one of the rear and front rollers via the motor, based on the state of the rotation mode switch.

15. The system of claim 14, wherein the real-time operational statuses that are indicated by the display portion during the bedding-in process further comprise an indication that the direction of rotation of the electric motor is set for a front wheel or a rear wheel of the cycle.

16. The system of claim 1, further comprising a wheel insertion sensor configured to detect the presence of the wheel within the opening engaged with the rear and front rollers, and wherein the at least one controller is configured to execute the bedding-in process only when the presence of the wheel is detected by the wheel insertion sensor.

17. The system of claim 1, wherein the real-time operational statuses that are indicated by the display portion are at least one of visually indicated, audibly indicated and tactically indicated to the user.

18. The system of claim 1, wherein the front roller and the rear roller each comprise an area of reduced diameter configured to engage and retain the wheel of the cycle thereon during the bedding-in process.

19. The system of claim 1, further comprising an exhaust system configured to remove fumes and airborne particles that are generated during the bedding-in process from an area extending about the system and wheel.

20. A method of bedding-in a disc brake of a wheeled cycle that comprises a brake rotor fixed to a wheel of the cycle and a pair of brake pads mounted on a caliper that selectively compress against the brake rotor while the wheel and rotor are rotating during a braking operation of the disc brake, comprising:
providing or obtaining a cycle disc brake bedding-in system, comprising:
a base;
a roller assembly rotatably coupled with the base;
an electric motor mounted operatively coupled with the roller assembly configured to rotate at least one of the rear and front rollers;
at least one user interface comprising a display portion and an input interface portion configured to input at least one operational parameter; and
at least one controller that monitors real-time operational statuses of the system, and controls the electric motor and the at least one user interface, based on the at least one operational parameter input by the input interface portion and the real-time operational statuses, to execute a bedding-in process that beds-in the disc brake of the wheel of the wheeled cycle while at least some of the real-time operational statuses are indicated by the display portion;
utilizing the input interface portion of the at least one user interface to input the at least one operational parameter to the system; and
utilizing the system to bed-in the disc brake of the wheel of the wheeled cycle via the bedding-in process, comprising:
initiating a bedding-in process of the system such that the wheel of the wheeled cycle is rotated by the roller assembly; and
performing a plurality of cycles of a braking operation followed by a cooling operation while the wheel of the wheeled cycle is rotated by the roller assembly,
wherein each braking operation comprises activating the disc brake for a braking timeframe at a braking level based on the display portion providing an indication to perform the braking operation and providing an indication of a real-time brake level compared to a defined braking level,
and wherein each cooling operation comprises deactivating the disc brake for a cooling timeframe based on the display portion providing an indication to perform a cooling operation.

21. The method of claim 20, wherein:
during each braking operation, the real-time operational statuses that are indicated by the display portion comprise the indication to perform the braking operation, the indication of the real-time brake level compared to the defined braking level, and an indication of a real-time status of an amount of time remaining in the braking timeframe; and
during each cooling operation, the real-time operational statuses that are indicated by the display portion comprise the indication to perform the cooling operation, and an indication of a real-time status of an amount of time remaining in the cooling timeframe.
